(19) United States
(12) Patent Application Publication
(10) Pub. No.: US 2025/0028786 A1
(43) Pub. Date: Jan. 23, 2025

(54) Implementing Matrix Multiplication on a Systolic Array with Reconfigurable Processing Elements

(71) Applicant: SambaNova Systems, Inc., Palo Alto, CA (US)

(72) Inventors: Mark William Gottscho, Mountain View, CA (US); Nasim Farahini, Täby (SE); Raghu PRABHAKAR, San Jose, CA (US); Hakan Zeffer, Enskede (SE)

(73) Assignee: SambaNova Systems, Inc., Palo Alto, CA (US)

(21) Appl. No.: 18/779,448

(22) Filed: Jul. 22, 2024

Related U.S. Application Data
(60) Provisional application No. 63/527,952, filed on Jul. 20, 2023.

(51) Int. Cl. G06F 17/16

(52) U.S. Cl. CPC G06F 17/16

(57) ABSTRACT

A compiler tool and a method of operating a compiler tool for selecting between executing a matrix multiplication operation in a weight stationary mode or in an output stationary mode on a systolic array with reconfigurable processing elements are presented. The compiler tool receives configuration parameters, energy parameters, and performance parameters as well as dimensions of the matrices to be multiplied and estimates energy consumptions and performance numbers for executing the matrix multiplication operation in the weight stationary and the output stationary modes. The compiler tool selects between operating the matrix multiplication operation in the weight stationary and the output stationary mode based on the estimated energy consumption and the estimated performance numbers.

### RELATED APPLICATIONS AND DOCUMENTS

This application claims the benefit of U.S. Provisional Patent Application No. 63/527,952, entitled, “Block Sparse Format Data Path” filed on 20 Jul. 2023. The provisional application is hereby incorporated by reference for all purposes.

This application is also related to the following papers and commonly owned applications:
Prabhakar et al., “Plasticine: A Reconfigurable Architecture for Parallel Patterns,” ISCA '17, Jun. 24-28, 2017, Toronto, ON, Canada;
Koeplinger et al., “Spatial: A Language And Compiler For Application Accelerators,” Proceedings Of The 39th ACM SIGPLAN Conference On Programming Language Design And Embodiment (PLDI), Proceedings of the 43rd International Symposium on Computer Architecture, 2018;
U.S. Nonprovisional patent application Ser. No. 16/239,252, now U.S. Pat. No. 10,698,853 B1, filed Jan. 3, 2019, entitled “VIRTUALIZATION OF A RECONFIGURABLE DATA PROCESSOR;”
U.S. Nonprovisional patent application Ser. No. 16/862,445, now U.S. Pat. No. 11,188,497 B2, filed Nov. 21, 2018, entitled “CONFIGURATION UNLOAD OF A RECONFIGURABLE DATA PROCESSOR;”
U.S. Nonprovisional patent application Ser. No. 16/197,826, now U.S. Pat. No. 10,831,507 B2, filed Nov. 21, 2018, entitled “CONFIGURATION LOAD OF A RECONFIGURABLE DATA PROCESSOR;”
U.S. Nonprovisional patent application Ser. No. 16/198,086, now U.S. Pat. No. 11,188,497 B2, filed Nov. 21, 2018, entitled “CONFIGURATION UNLOAD OF A RECONFIGURABLE DATA PROCESSOR;”
U.S. Nonprovisional patent application Ser. No. 17/093,543, filed Nov. 9, 2020, entitled “EFFICIENT CONFIGURATION OF A RECONFIGURABLE DATA PROCESSOR;”
U.S. Nonprovisional patent application Ser. No. 16/260,548, now U.S. Pat. No. 10,768,899 B2, filed Jan. 29, 2019, entitled “MATRIX NORMAL/TRANSPOSE READ AND A RECONFIGURABLE DATA PROCESSOR INCLUDING SAME;”
U.S. Nonprovisional patent application Ser. No. 16/536,192, now U.S. Pat. No. 11,080,227 B2, filed Aug. 8, 2019, entitled “COMPILER FLOW LOGIC FOR RECONFIGURABLE ARCHITECTURES;”
U.S. Nonprovisional patent application Ser. No. 17/326,128, filed May 20, 2021, entitled “COMPILER FLOW LOGIC FOR RECONFIGURABLE ARCHITECTURES;”
U.S. Nonprovisional patent application Ser. No. 16/407,675, now U.S. Pat. No. 11,386,038 B2, filed May 9, 2019, entitled “CONTROL FLOW BARRIER AND RECONFIGURABLE DATA PROCESSOR;”
U.S. Nonprovisional patent application Ser. No. 16/504,627, now U.S. Pat. No. 11,055,141 B2, filed Jul. 8, 2019, entitled “QUIESCE RECONFIGURABLE DATA PROCESSOR;”
U.S. Nonprovisional patent application Ser. No. 17/322,697, filed May 17, 2021, entitled “QUIESCE RECONFIGURABLE DATA PROCESSOR;”
U.S. Nonprovisional patent application Ser. No. 16/572,516, filed Sep. 16, 2019, entitled “EFFICIENT EXECUTION OF OPERATION UNIT GRAPHS ON RECONFIGURABLE ARCHITECTURES BASED ON USER SPECIFICATION;”
U.S. Nonprovisional patent application Ser. No. 16/744,077, filed Jan. 15, 2020, entitled “COMPUTATIONALLY EFFICIENT SOFTMAX LOSS GRADIENT BACKPROPAGATION;”
U.S. Nonprovisional patent application Ser. No. 16/590,058, now U.S. Pat. No. 11,327,713 B2, filed Oct. 1, 2019, entitled “COMPUTATION UNITS FOR FUNCTIONS BASED ON LOOKUP TABLES;”
U.S. Nonprovisional patent application Ser. No. 16/695,138, now U.S. Pat. No. 11,328,038 B2, filed Nov. 25, 2019, entitled “COMPUTATIONAL UNITS FOR BATCH NORMALIZATION;”
U.S. Nonprovisional patent application Ser. No. 16/688,069, filed Nov. 19, 2019, now U.S. Pat. No. 11,327,717 B2, entitled “LOOK-UP TABLE WITH INPUT OFFSETTING;”
U.S. Nonprovisional patent application Ser. No. 16/718,094, filed Dec. 17, 2019, now U.S. Pat. No. 11,150,872 B2, entitled “COMPUTATIONAL UNITS FOR ELEMENT APPROXIMATION;”
U.S. Nonprovisional patent application Ser. No. 16/560,057, now U.S. Pat. No. 11,327,923 B2, filed Sep. 4, 2019, entitled “SIGMOID FUNCTION IN HARDWARE AND A RECONFIGURABLE DATA PROCESSOR INCLUDING SAME;”
U.S. Nonprovisional patent application Ser. No. 16/572,527, now U.S. Pat. No. 11,410,027 B2, filed Sep. 16, 2019, entitled “Performance Estimation-Based Resource Allocation for Reconfigurable Architectures;”
U.S. Nonprovisional patent application Ser. No. 15/930,381, now U.S. Pat. No. 11,250,105 B2, filed May 12, 2020, entitled “COMPUTATIONALLY EFFICIENT GENERAL MATRIX-MATRIX MULTIPLICATION (GEMM);”
U.S. Nonprovisional patent application Ser. No. 17/337,080, now U.S. Pat. No. 11,328,209 B1, filed Jun. 2, 2021, entitled “MEMORY EFFICIENT DROPOUT;”
U.S. Nonprovisional patent application Ser. No. 17/337,126, now U.S. Pat. No. 11,256,987 B1, filed Jun. 2, 2021, entitled “MEMORY EFFICIENT DROPOUT, WITH REORDERING OF DROPOUT MASK ELEMENTS;”
U.S. Nonprovisional patent application Ser. No. 16/890,841, filed Jun. 2, 2020, entitled “ANTI-CONGESTION FLOW CONTROL FOR RECONFIGURABLE PROCESSORS;”
U.S. Nonprovisional patent application Ser. No. 17/023,015, now U.S. Pat. No. 11,237,971 B1, filed Sep. 16, 2020, entitled “COMPILE TIME LOGIC FOR DETECTING STREAMING COMPATIBLE AND BROADCAST COMPATIBLE DATA ACCESS PATTERNS;”
U.S. Nonprovisional patent application Ser. No. 17/031,679, filed Sep. 24, 2020, entitled “SYSTEMS AND METHODS FOR MEMORY LAYOUT DETERMINATION AND CONFLICT RESOLUTION;”
U.S. Nonprovisional patent application Ser. No. 17/175,289, now U.S. Pat. No. 11,126,574 B1, filed Feb. 12, 2021, entitled “INSTRUMENTATION PROFILING FOR RECONFIGURABLE PROCESSORS;”
U.S. Nonprovisional patent application Ser. No. 17/371,049, filed Jul. 8, 2021, entitled “SYSTEMS AND METHODS FOR EDITING TOPOLOGY OF A RECONFIGURABLE DATA PROCESSOR;”
U.S. Nonprovisional patent application Ser. No. 16/922,975, filed Jul. 7, 2020, entitled “RUNTIME VIRTUALIZATION OF RECONFIGURABLE DATA FLOW RESOURCES;”
U.S. Nonprovisional patent application Ser. No. 16/996,666, filed Aug. 18, 2020, entitled “RUNTIME PATCHING OF CONFIGURATION FILES;”
U.S. Nonprovisional patent application Ser. No. 17/214,768, now U.S. Pat. No. 11,200,096 B1, filed Mar. 26, 2021, entitled “RESOURCE ALLOCATION FOR RECONFIGURABLE PROCESSORS;”
U.S. Nonprovisional patent application Ser. No. 17/127,818, now U.S. Pat. No. 11,182,264 B1, filed Dec. 18, 2020, entitled “INTRA-NODE BUFFER-BASED STREAMING FOR RECONFIGURABLE PROCESSOR-AS-A-SERVICE (RPAAS);”
U.S. Nonprovisional patent application Ser. No. 17/127,929, now U.S. Pat. No. 11,182,221 B1, filed Dec. 18, 2020, entitled “INTER-NODE BUFFER-BASED STREAMING FOR RECONFIGURABLE PROCESSOR-AS-A-SERVICE (RPAAS);”
U.S. Nonprovisional patent application Ser. No. 17/185,264, filed Feb. 25, 2021, entitled “TIME-MULTIPLEXED USE OF RECONFIGURABLE HARDWARE;”
U.S. Nonprovisional patent application Ser. No. 17/216,647, now U.S. Pat. No. 11,204,889 B1, filed Mar. 29, 2021, entitled “TENSOR PARTITIONING AND PARTITION ACCESS ORDER;”
U.S. Nonprovisional patent application Ser. No. 17/216,650, now U.S. Pat. No. 11,366,783 B1, filed Mar. 29, 2021, entitled “MULTI-HEADED MULTI-BUFFER FOR BUFFERING DATA FOR PROCESSING;”
U.S. Nonprovisional patent application Ser. No. 17/216,657, now U.S. Pat. No. 11,263,170 B1, filed Mar. 29, 2021, entitled “LOSSLESS TILING IN CONVOLUTION NETWORKS-PADDING BEFORE TILING, LOCATION-BASED TILING, AND ZEROING-OUT;”
U.S. Nonprovisional patent application Ser. No. 17/384,515, filed Jul. 23, 2021, entitled “LOSSLESS TILING IN CONVOLUTION NETWORKS-MATERIALIZATION OF TENSORS;”
U.S. Nonprovisional patent application Ser. No. 17/216,651, now U.S. Pat. No. 11,195,080 B1, filed Mar. 29, 2021, entitled “LOSSLESS TILING IN CONVOLUTION NETWORKS-TILING CONFIGURATION;”
U.S. Nonprovisional patent application Ser. No. 17/216,652, now U.S. Pat. No. 11,227,207 B1, filed Mar. 29, 2021, entitled “LOSSLESS TILING IN CONVOLUTION NETWORKS-SECTION BOUNDARIES;”
U.S. Nonprovisional patent application Ser. No. 17/216,654, now U.S. Pat. No. 11,250,061 B1, filed Mar. 29, 2021, entitled “LOSSLESS TILING IN CONVOLUTION NETWORKS-READ-MODIFY-WRITE IN BACKWARD PASS;”
U.S. Nonprovisional patent application Ser. No. 17/216,655, now U.S. Pat. No. 11,232,360 B1, filed Mar. 29, 2021, entitled “LOSSLESS TILING IN CONVOLUTION NETWORKS-WEIGHT GRADIENT CALCULATION;”
U.S. Nonprovisional patent application Ser. No. 17/364,110, filed Jun. 30, 2021, entitled “LOSSLESS TILING IN CONVOLUTION NETWORKS-TILING CONFIGURATION FOR A SEQUENCE OF SECTIONS OF A GRAPH;”
U.S. Nonprovisional patent application Ser. No. 17/364,129, filed Jun. 30, 2021, entitled “LOSSLESS TILING IN CONVOLUTION NETWORKS-TILING CONFIGURATION BETWEEN TWO SECTIONS;”
“U.S. Nonprovisional patent application Ser. No. 17/364,141, filed Jun. 30, 2021, entitled ““LOSSLESS TILING IN CONVOLUTION NETWORKS-PADDING AND RE-TILLING AT SECTION BOUNDARIES;”
U.S. Nonprovisional patent application Ser. No. 17/384,507, filed Jul. 23, 2021, entitled “LOSSLESS TILING IN CONVOLUTION NETWORKS-BACKWARD PASS;”
U.S. Provisional Patent Application No. 63/107,413, filed Oct. 29, 2020, entitled “SCANNABLE LATCH ARRAY FOR STRUCTURAL TEST AND SILICON DEBUG VIA SCANDUMP;”
U.S. Provisional Patent Application No. 63/165,073, filed Mar. 23, 2021, entitled “FLOATING POINT MULTIPLY-ADD, ACCUMULATE UNIT WITH CARRY-SAVE ACCUMULATOR IN BF16 AND FLP32 FORMAT;”
U.S. Provisional Patent Application No. 63/166,221, filed Mar. 25, 2021, entitled “LEADING ZERO AND LEADING ONE DETECTOR PREDICTOR SUITABLE FOR CARRY-SAVE FORMAT;”
U.S. Provisional Patent Application No. 63/174,460, filed Apr. 13, 2021, entitled “EXCEPTION PROCESSING IN CARRY-SAVE ACCUMULATION UNIT FOR MACHINE LEARNING;”
U.S. Nonprovisional patent application Ser. No. 17/397,241, now U.S. Pat. No. 11,429,349 B1, filed Aug. 9, 2021, entitled “FLOATING POINT MULTIPLY-ADD, ACCUMULATE UNIT WITH CARRY-SAVE ACCUMULATOR;”
U.S. Nonprovisional patent application Ser. No. 17/216,509, now U.S. Pat. No. 11,191,182 B1, filed Mar. 29, 2021, entitled “UNIVERSAL RAIL KIT;”
U.S. Nonprovisional patent application Ser. No. 17/379,921, now U.S. Pat. No. 11,392,740 B2, filed Jul. 19, 2021, entitled “DATAFLOW FUNCTION OFFLOAD TO RECONFIGURABLE PROCESSORS;”
U.S. Nonprovisional patent application Ser. No. 17/379,924, now U.S. Pat. No. 11,237,880 B1, filed Jul. 19, 2021, entitled “DATAFLOW ALL-REDUCE FOR RECONFIGURABLE PROCESSOR SYSTEMS;”
U.S. Nonprovisional patent application Ser. No. 17/378,342, now U.S. Pat. No. 11,556,494 B1, filed Jul. 16, 2021, entitled “DEFECT REPAIR FOR A RECONFIGURABLE DATA PROCESSOR;”
U.S. Nonprovisional patent application Ser. No. 17/378,391, now U.S. Pat. No. 11,327,771 B1, filed Jul. 16, 2021, entitled “DEFECT REPAIR CIRCUITS FOR A RECONFIGURABLE DATA PROCESSOR;”
U.S. Nonprovisional patent application Ser. No. 17/378,399, now U.S. Pat. No. 11,409,540 B1, filed Jul. 16, 2021, entitled “ROUTING CIRCUITS FOR DEFECT REPAIR FOR A RECONFIGURABLE DATA PROCESSOR;”
U.S. Provisional Patent Application No. 63/220,266, filed Jul. 9, 2021, entitled “LOGIC BIST AND FUNCTIONAL TEST FOR A CGRA;”
U.S. Provisional Patent Application No. 63/195,664, filed Jun. 1, 2021, entitled “VARIATION-TOLERANT VARIABLE-LENGTH CLOCK-STRETCHER MODULE WITH IN-SITU END-OF-CHAIN DETECTION MECHANISM;”
U.S. Nonprovisional patent application Ser. No. 17/338,620, now U.S. Pat. No. 11,323,124 B1, filed Jun. 3, 2021, entitled “VARIABLE-LENGTH CLOCK STRETCHER WITH CORRECTION FOR GLITCHES DUE TO FINITE DLL BANDWIDTH;”
U.S. Nonprovisional patent application Ser. No. 17/338,625, now U.S. Pat. No. 11,239,846 B1, filed Jun. 3, 2021, entitled “VARIABLE-LENGTH CLOCK STRETCHER WITH CORRECTION FOR GLITCHES DUE TO PHASE DETECTOR OFFSET;”
U.S. Nonprovisional patent application Ser. No. 17/338,626, now U.S. Pat. No. 11,290,113 B1, filed Jun. 3, 2021, entitled “VARIABLE-LENGTH CLOCK STRETCHER WITH CORRECTION FOR DIGITAL DLL GLITCHES;”
U.S. Nonprovisional patent application Ser. No. 17/338,629, now U.S. Pat. No. 11,290,114 B1, filed Jun. 3, 2021, entitled “VARIABLE-LENGTH CLOCK STRETCHER WITH PASSIVE MODE JITTER REDUCTION;”
U.S. Nonprovisional patent application Ser. No. 17/405,913, now U.S. Pat. No. 11,334,109 B1, filed Aug. 18, 2021, entitled “VARIABLE-LENGTH CLOCK STRETCHER WITH COMBINER TIMING LOGIC;”
U.S. Provisional Patent Application No. 63/230,782, filed Aug. 8, 2021, entitled “LOW-LATENCY MASTER-SLAVE CLOCKED STORAGE ELEMENT;”
U.S. Provisional Patent Application No. 63/236,218, filed Aug. 23, 2021, entitled “SWITCH FOR A RECONFIGURABLE DATAFLOW PROCESSOR;”
U.S. Provisional Patent Application No. 63/236,214, filed Aug. 23, 2021, entitled “SPARSE MATRIX MULTIPLIER;”
U.S. Provisional Patent Application No. 63/389,767, filed Jul. 15, 2022. entitled “PEER-TO-PEER COMMUNICATION BETWEEN RECONFIGURABLE DATAFLOW UNITS;”
U.S. Provisional Patent Application No. 63/405,240, filed Sep. 9, 2022, entitled “PEER-TO-PEER ROUTE THROUGH IN A RECONFIGURABLE COMPUTING SYSTEM.”
   All of the related application(s) and documents listed above are hereby incorporated by reference herein for all purposes.

### FIELD OF THE TECHNOLOGY DISCLOSED

The present technology relates to a method of operating a compiler tool, and more particularly to a method of operating a compiler tool for selecting between executing a matrix multiplication operation in a weight stationary mode or in an output stationary mode on a systolic array with reconfigurable processing elements. Furthermore, the present technology relates to a system for implementing a processing graph on a systolic array with reconfigurable processing elements, the system including a compiler tool for selecting between executing a matrix multiplication operation in a weight stationary mode or in an output stationary mode on the systolic array. Moreover, the present technology relates to a non-transitory computer-readable storage medium including instructions that, when executed by a processing unit, cause the processing unit to operate a compiler tool for selecting between executing a matrix multiplication operation in a weight stationary mode or in an output stationary mode on a systolic array with reconfigurable processing elements.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Deep learning is a subset of machine learning algorithms that are inspired by the structure and function of the human brain. Most deep learning algorithms involve artificial neural network architectures, in which multiple layers of neurons each receive input from neurons in a prior layer or layers, and in turn influence the neurons in the subsequent layer or layers. Training these neural network models can be computationally extremely demanding.

As machine learning based technologies are more widely deployed, it is becoming important to implement them at low cost using flexible hardware architectures. In such architectures, including integrated circuit components, area, and power consumption are critical design parameters. One class of integrated circuits includes reconfigurable processors.

Reconfigurable processors can be configured to implement a variety of functions. In particular, so-called Coarse-Grained Reconfigurable Architectures (CGRAs) are being developed in which the configurable units in the array are complex and that may enable faster or more efficient execution of various classes of functions. For example, CGRAs have been proposed that can enable implementation of energy-efficient accelerators for machine learning and artificial intelligence workloads. See, Prabhakar, et al., “Plasticine: A Reconfigurable Architecture for Parallel Patterns,” ISCA '17, Jun. 24-28, 2017, Toronto, ON, Canada. Various aspects of some of such CGRAs are described in the above-incorporated patent applications.

A CGRA typically includes an array of reconfigurable units and operate on streams of data and control messages that flow through a sea of these reconfigurable units, sometimes referred to herein as Coarse-Grained Reconfigurable Units (CGRUs). The units can comprise somewhat specialized computational and memory units.

The heart of deep learning is matrix multiplication. Thus, matrix multiplication is used in many applications for machine learning and artificial intelligence. Furthermore, matrix multiplication forms the basis for many computations in linear algebra because it is the core routine behind the Level-3 basic linear algebra subprograms (BLAS) and much of linear algebra package (LAPACK).

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings.

FIG. 1 is a diagram of an illustrative matrix multiplication of a first matrix with a second matrix to produce a result matrix.

FIG. 2 is a diagram of an illustrative reconfigurable processor that is configured to perform a matrix multiplication of the first matrix with the second matrix of FIG. 1 in an output stationary mode.

FIG. 3 is a diagram of an illustrative reconfigurable processor that is configured to perform a matrix multiplication of the first matrix with the second matrix of FIG. 1 in a weight stationary mode.

FIG. 4 is a diagram of an illustrative systolic array with a plurality of reconfigurable processing elements.

FIG. 5A is a diagram of an illustrative processing element operating in an output stationary mode.

FIG. 5B is a diagram of an illustrative processing element operating in a weight stationary mode.

FIG. 6 is a diagram of an illustrative reconfigurable processing element for a systolic array that is configurable for multiplying a first matrix with a second matrix to determine a result matrix in a weight stationary mode or in an output stationary mode.

FIG. 7 is a diagram of an illustrative compiler tool for selecting between executing a matrix multiplication operation in a weight stationary mode or in an output stationary mode on a systolic array with reconfigurable processing elements.

FIG. 8A is a flowchart showing a first portion of illustrative operations that a compiler tool performs for selecting between executing a matrix multiplication operation in a weight stationary mode or in an output stationary mode on a systolic array with reconfigurable processing elements.

FIG. 8B is a flowchart showing a second portion of illustrative operations that a compiler tool performs for selecting between executing a matrix multiplication operation in a weight stationary mode or in an output stationary mode on a systolic array with reconfigurable processing elements.

### DETAILED DESCRIPTION

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

Traditional compilers translate human-readable computer source code into machine code that can be executed on a Von Neumann computer architecture. In this architecture, a processor serially executes instructions in one or more threads of software code. The architecture is static and the compiler does not determine how execution of the instructions is pipelined, or which processor or memory takes care of which thread. Thread execution is asynchronous, and safe exchange of data between parallel threads is not supported.

Applications for machine learning (ML) and artificial intelligence (AI) may require massively parallel computations, where many parallel and interdependent threads (metapipelines) exchange data. Therefore, such applications are ill-suited for execution on Von Neumann computers.

Moreover, as mentioned above, matrix multiplication is used in many applications for machine learning and artificial intelligence and forms the basis for many computations in linear algebra. Matrix multiplication operations require architectures that are adapted for parallel processing,

Systolic arrays are an extremely attractive platform for performing matrix multiplication when performance, power, or energy efficiency are paramount. A systolic array has a parallel architecture, made out of relatively simple processors, that are regularly and locally connected. The data circulate through these processors in a synchronous manner and interact where they meet.

Coarse-grained reconfigurable architectures (CGRAs) may be configured to implement a systolic array for matrix multiplication. Traditionally, systolic arrays perform matrix multiplication either in an input stationary mode, which is sometimes also referred to as weight stationary mode or in an output stationary mode.

US Nonprovisional Patent Application No. TBD, “A RECONFIGURABLE PROCESSING ELEMENT FOR A SYSTOLIC ARRAY”, to Gottscho et al., filed on the same day as this application and incorporated herein by reference, describes a reconfigurable processing element for a systolic array that is configurable for multiplying a first matrix with a second matrix to determine a result matrix in a weight stationary mode or in an output stationary mode. If desired, such a reconfigurable processing element may be integrated into a coarse-grained reconfigurable architecture.

However, depending on the dimensions of the matrices, depending on the configuration parameters of the systolic array (e.g., architecture of the processing elements and/or the connectivity of the processing elements in the systolic array) as well as depending on the energy and performance parameters related to executing predetermined operations on the systolic array including operations that involve external interfaces such as memory interfaces of the systolic array, operating in weight stationary mode may be more efficient than operating in output stationary mode or vice versa.

Therefore, it is desirable to provide a compiler tool for selecting between executing a matrix multiplication operation in a weight stationary mode or in an output stationary mode on a systolic array with reconfigurable processing elements.

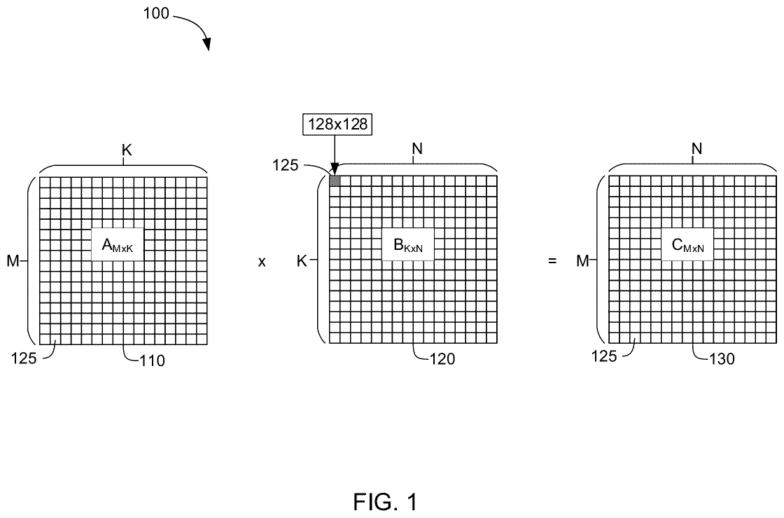

FIG. 1 is a diagram of an illustrative matrix multiplication operation 100 of a first matrix A 110 with a second matrix B 120 to produce a result matrix C 130. Illustratively, the first matrix A 110 has M rows and K columns, the second matrix B 120 has K rows and N columns, and the result matrix C 130 has M rows and N columns.

As an example, consider the scenario in which every square element 125 of matrices A 110, B 120, and C 130 includes 128 rows and 128 columns. Consider further that each one of matrices A 110, B 120, and C 130 has 16 rows and 16 columns of square elements 125 for a total of 256 square elements from square element 0, 0 to square element 15, 15. In this scenario, matrix A 110 has M=2048 rows and K=2048 columns, matrix B has K=2048 rows and N=2048 columns, and matrix C has M=2048 rows and N=2048 columns.

In this example, M is equal to K and equal to N. However, M, K, and N may be different numbers, and thus the matrices may have different dimensions, if desired.

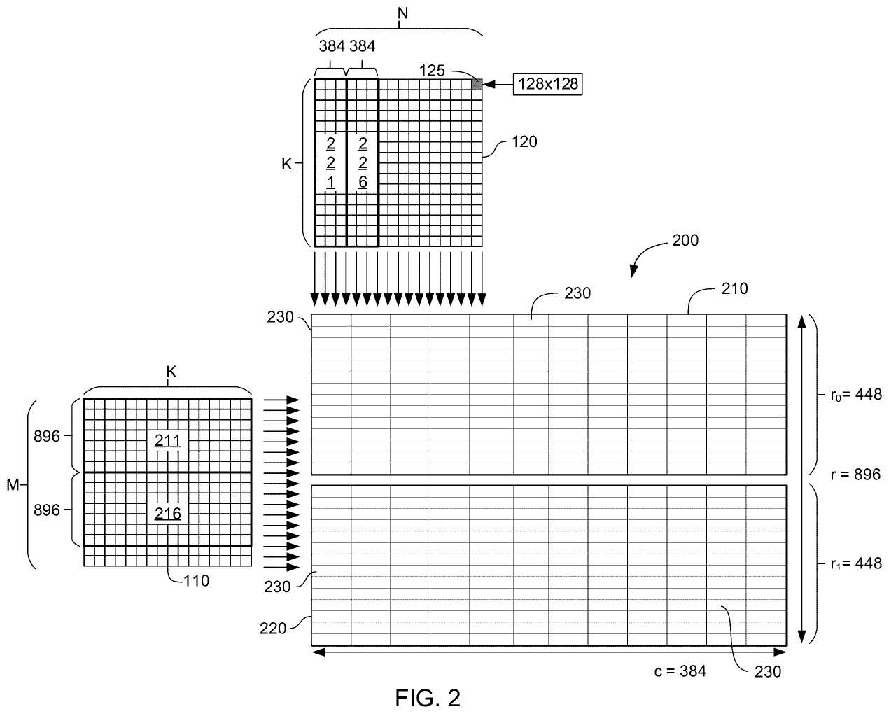

FIG. 2 is a diagram of an illustrative reconfigurable processor 200 that is configured to perform a matrix multiplication of the first matrix A 110 with the second matrix B 120 of FIG. 1 in an output stationary mode. The reconfigurable processor may be a coarse-grained reconfigurable processor, if desired.

Illustratively, the reconfigurable processor 200 may include two tiles, tile 210 and tile 220. As shown in FIG. 2, tile 210 may be arranged vertically on top of tile 220. However, tile 210 may be arranged horizontally next to tile 220, if desired. In some implementations, the reconfigurable processor 200 may include only one tile, so that the two tiles are in two different reconfigurable processors. In other implementations, the reconfigurable processor 200 may include more than two tiles. For example, the reconfigurable processor 200 may include three, four, or more tiles.

The tiles may be arranged in any way relative to each other. As an example, four tiles may be arranged two-by-two tiles in a same plane. As another example, all four tiles may be arranged in a row or in a column. As yet another example, two tiles may be arranged in a same plane next to each other and the other two tiles may be arranged in another plane next to each other, whereby the two planes may be vertically stacked.

In some implementations, tile 210 and tile 220 may each include an array of reconfigurable processing elements. The reconfigurable processing elements may be grouped in programmable compute units (PCUs), if desired. A tile 210, 220 may include any number of rows and columns of PCUs 230 having any number of reconfigurable processing elements.

As an example, consider the scenario shown in FIG. 2 in which tile 210 and tile 220 each have 14 rows and 12 columns of PCUs 230. Consider further that each PCU 230 has 32 rows of reconfigurable processing units and 32 columns of reconfigurable processing units. Thus, each PCU 230 has 1024 reconfigurable processing units, each tile 210, 220 has c=384 columns of reconfigurable processing elements and 448 rows of reconfigurable processing elements, and both tiles as arranged in FIG. 2 have a total of r=896 rows of reconfigurable processing elements.

Tile 210 and tile 220 may together be configured to implement a systolic array for multiplying matrix A 110 with matrix B 120 in the output stationary mode. In the output stationary mode, the result matrix (e.g., matrix C 130 of FIG. 1) may be initialized to zero inside the reconfigurable processing elements of the systolic array. Matrices A 110 and B 120 may be streamed into the systolic array.

As shown in FIG. 2, matrix A 110 is streamed into the systolic array from the left and matrix B 120 is streamed into the systolic array from the top. However, matrices A and B may be streamed into the systolic array from any two sides depending on the configuration of the reconfigurable processing elements and the connectivity within the systolic array. For example, matrix A may be streamed from the top and matrix B from the left, or matrix A may be streamed into the systolic array from the bottom and matrix B from the right, just to name a few alternatives for streaming the matrices A and B into the systolic array.

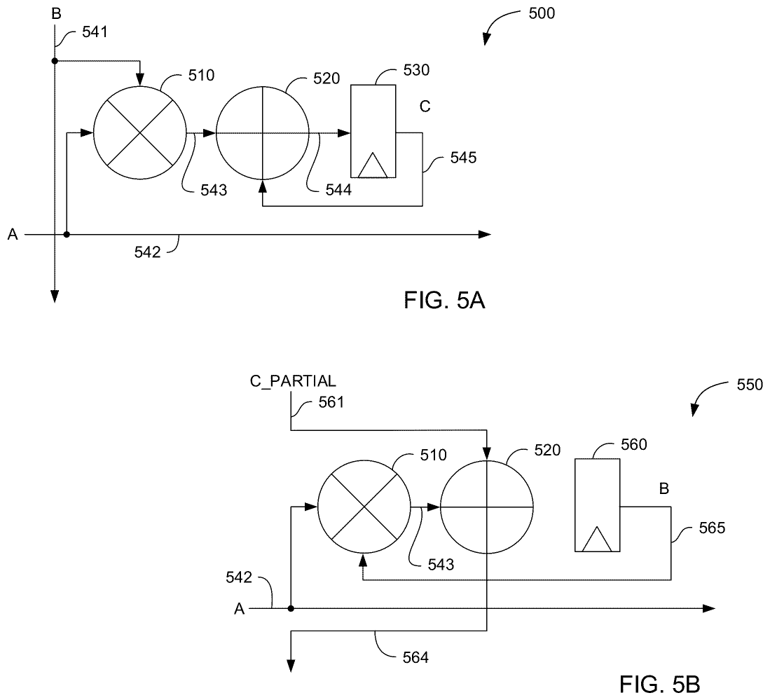

Each reconfigurable processing element implements a multiply-accumulate function and computes a single element of the result matrix C:

$$\\ \begin{matrix}c [ m ] [ n ] += a [ m ] [ k ] * b [ k ] [ n ] & ( 1 )\end{matrix}$$

where k is iterated in time from 0 to K and m and n are spatial indices of the row and the column of the reconfigurable processing element, respectively. After k=K steps, the matrix C is streamed out from the bottom of the systolic array. An illustrative processing element that operates in the output stationary mode is shown in FIG. 5A.

However, in the present example of FIG. 2, the number of rows of reconfigurable processing elements of the two tiles r=896 is smaller than the number of rows M=2048 of matrix A 110. Furthermore, the number of columns of reconfigurable processing elements of the two tiles c=384 is smaller than the number of columns N=2048 of matrix B 120. Consequently, if M>r, matrix multiplication in the output stationary mode requires multiple row iterations, and if N>c, matrix multiplication in the output stationary mode requires multiple column iterations.

In some implementations, the portions of matrices A 110 and B 120 that are to be multiplied are loaded from off-chip memory (e.g., DRAM) into on-chip memory (e.g., SRAM) of the systolic array, and the portions of the matrices are then streamed into the systolic array from the on-chip memory. Similarly, the result matrix may first be stored in on-chip memory before the result matrix is moved to off-chip memory. However, the size of the on-chip memory may be limited, and the matrix multiplication operation may require multiple load operations from off-chip memory to on-chip memory and multiple store operations of portions of the result matrix from on-chip memory to off-chip memory depending on the dimensions M, N, and K of the matrices.

In the present example, in a first iteration, the two tiles 210, 220 may multiply the elements in the rectangle 211 that includes the upper 896 rows (i.e., row 0 to row 895) and K columns of matrix A 110 with the elements in the rectangle 221 that includes the K rows and the leftmost 384 columns (i.e., column 0 to column 383) of matrix B 120 to determine the upper left rectangle of the result matrix including 896 rows and 384 columns (i.e., rows 0 to 895 and columns 0 to 383 of the result matrix), which are streamed out and stored (e.g., on an SRAM circuit on the reconfigurable processor 200 and from there copied to a DRAM circuit outside the reconfigurable processor 200).

In a second iteration, the two tiles 210, 220 may multiply the elements in the rectangle 211 that includes the upper 896 rows and K columns of matrix A 110 with the elements in the rectangle 226 that includes the K rows and the next 384 columns (i.e., column 384 to column 767) of matrix B 120 to determine the elements in the rectangle that includes rows 0 to 895 and columns 384 to 767 of the result matrix.

Alternatively, in the second iteration, the two tiles 210, 220 may multiply the elements in the rectangle 216 that includes the next 896 rows (i.e., rows 896 to 1791) and K columns of matrix A 110 with the elements in the rectangle 221 that includes the K rows and the leftmost 384 columns (i.e., column 0 to column 383) of matrix B 120 to de determine the elements in the rectangle that includes rows 896 to 1791 and columns 0 to 383 of the result matrix.

The iterations continue until the entire result matrix has been determined. In the present example, the two tiles 210, 220 may determine the entire result matrix in 18 iterations.

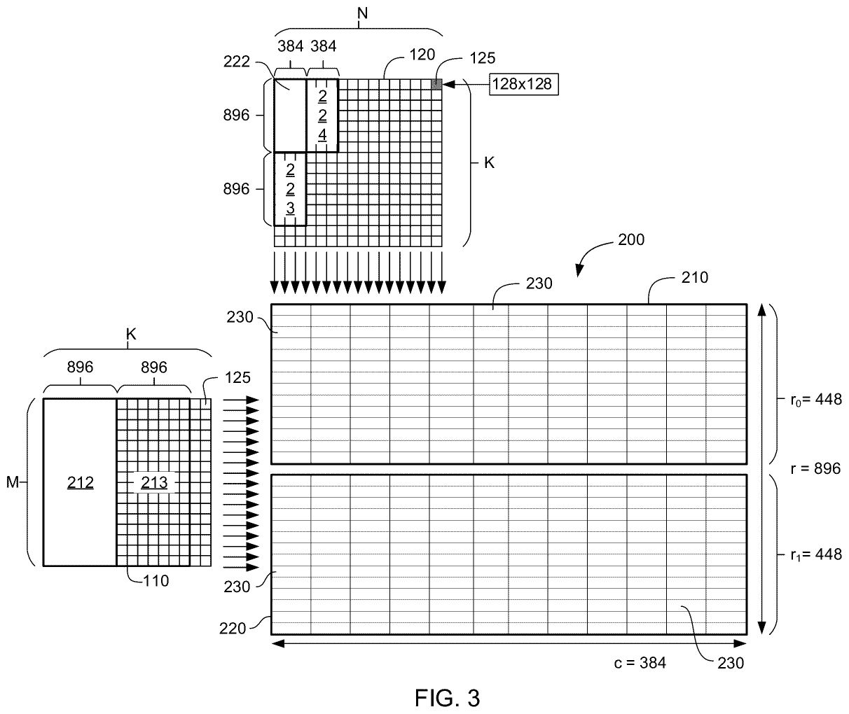

FIG. 3 is a diagram of an illustrative reconfigurable processor that is configured to perform a matrix multiplication of matrix A 110 with matrix B 120 of FIG. 1 in a weight stationary mode. Illustratively, the reconfigurable processor is the reconfigurable processor 200 with tiles 210 and 220 described in FIG. 2 above.

In contrast to FIG. 2, tile 210 and tile 220 of FIG. 3 may together be configured to implement a systolic array for multiplying matrix A 110 with matrix B 120 in the weight stationary mode. In the weight stationary mode, one of matrix A 110 or matrix B 120 is preloaded into internal registers of the processing elements within the systolic array. As an example, matrix B 120 may be preloaded from the top and matrix A 110 may be streamed into the systolic array from the left. As another example, matrix A 110 may be preloaded from the top and matrix B 120 may be streamed into the systolic array from the left. As yet another example, matrix B 120 may be preloaded from the bottom and matrix A 110 may be streamed into the systolic array from the right. For simplicity and conciseness, in the remainder of the description of FIG. 3, consider the scenario in which matrix B 120 is preloaded from the top, and matrix A 110 is streamed from the left.

In the weight stationary mode, the multiplier circuit in a processing element multiplies a number of matrix A 110 received from the left with a number of matrix B 120 that is stored in the internal register of the processing element (i.e., stationary) to generate a product. The adder circuit in the processing element adds the product to a partial sum received from the processing element above to generate an updated partial sum. The processing element outputs the updated partial sum at the bottom for transmission to the processing element below. An illustrative processing element that operates in the weight stationary mode is shown in FIG. 5B.

At the bottom of the systolic array, the partial sums may be buffered and accumulated before the result matrix C 130 is produced as a final output and copied to storage circuitry outside the reconfigurable processor 200.

In the present example of FIG. 3, the number of rows of reconfigurable processing elements of the two tiles r=896 is smaller than the number of rows K=2048 of matrix B 120. Furthermore, the number of columns of reconfigurable processing elements of the two tiles c=384 is smaller than the number of columns N=2048 of matrix B 120. Consequently, if K>r or N>c, matrix multiplication in the weight stationary mode requires loading of each tile (i.e., tile 222, tile 223, tile 224, etc.) of matrix B 120 at least once per block matrix multiplication.

In the present example, in a first iteration, the elements in the rectangle 222 in the upper left corner of matrix B 120 including 896 rows (i.e., rows 0 to 895) and 384 columns (i.e., columns 0 to 383) are preloaded into the internal registers of the two tiles 210, 220 during a load phase that occurs before matrix A 110 is streamed into the systolic array.

In some implementations, the internal registers of the two tiles 210, 220 may be enabled for a write operation only during the load phase. After the load phase has terminated, the systolic array may multiply the elements in the rectangle 212 that includes the M rows and leftmost 896 columns of matrix A 110 with the elements in the rectangle 222 that includes the uppermost 896 rows (i.e., row 0 to row 895) and the leftmost 384 columns (i.e., column 0 to column 383) of matrix B 120 to determine partial results of the leftmost 384 columns of the result matrix, which are streamed from the top of tile 210 to the bottom of tile 220 and added to the partial results in the processing elements that are traversed. The resulting partial results are stored on-chip at the bottom of the systolic array or off-chip (e.g., on a DRAM circuit outside the systolic array).

In a second iteration, the elements in the rectangle 223 of 896 rows and 384 columns below the rectangle 222 in the upper left corner of matrix B 120 (i.e., rows 896 to 1791 and columns 0 to 383) is preloaded into the internal registers of the two tiles 210, 220 during a second load phase. After the second load phase has terminated, the systolic array may multiply the elements in the rectangle 212 that includes the M rows and 896 leftmost columns (i.e., columns 0 to 895) of matrix A 110 with the elements in the rectangle 223 that includes the next 896 rows and 384 columns of matrix B and add the results to the partial results determined during the first iteration.

As an alternative, in the second iteration, the two tiles 210, 220 may keep the elements in the rectangle 222 in the upper left corner of matrix B 120 of the first iteration in the internal registers, and the systolic array may multiply the elements in the rectangle 213 that includes the M rows and 896 next columns (i.e., columns 896 to 1791) of matrix A 110 with the elements in the rectangle 222 that includes the uppermost 896 rows and the leftmost 384 columns of matrix B 120 and add the results to the partial results determined during the first iteration.

As another alternative, in the second iteration, the elements in the rectangle 224 of 896 rows and 384 columns to the right of the rectangle 222 of matrix B 120 (i.e., rows 0 to 895 and columns 384 to 767) may be preloaded into the internal registers of the two tiles 210, 220 during the second load phase. After the load phase has terminated, the systolic array may multiply the elements in the rectangle 212 that includes the M rows and leftmost 896 columns of matrix A 110 with the elements in the rectangle 224 that includes row 0 to 895 and columns 384 to 767 of matrix B to determine partial results of the second leftmost 384 columns of the result matrix, which are produced and stored on-chip at the bottom of the systolic array or off-chip (e.g., on a DRAM circuit outside the systolic array).

The iterations continue until the entire result matrix has been determined. In the present example, the two tiles 210, 220 may have determined the entire result matrix in 54 iterations.

Depending on the dimensions M, K, and N of the matrices (e.g., dimensions M, K, and N of matrices A 110 and B 120 of FIG. 1) and depending on the architecture of the systolic array, the on-chip memory capacity, the load time and energy requirements of loading into the on-chip memory, one of the output stationary mode or the weight stationary mode may be advantageous over the other one in terms of bandwidth, memory bandwidth, in terms of energy, and/or in terms of performance.

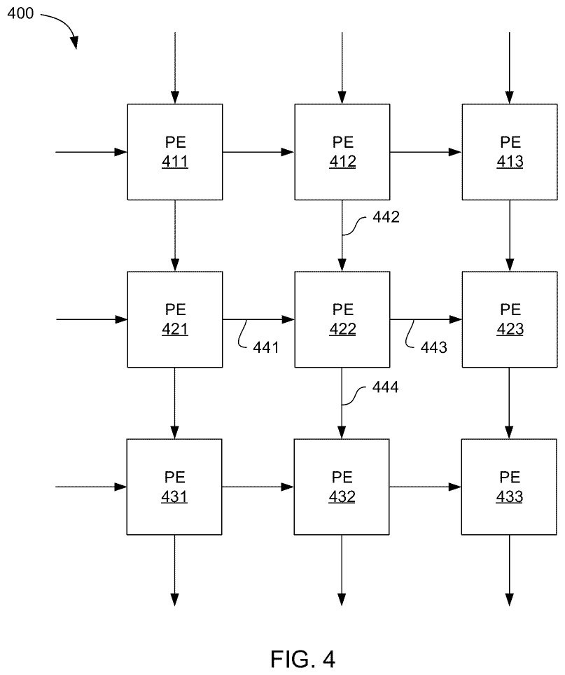

FIG. 4 is a diagram of an illustrative systolic array 400 with a plurality of reconfigurable processing elements. In FIG. 4, the illustrative systolic array 400 is shown with nine reconfigurable processing elements 411, 412, 413, 421, 422, 423, 431, 432, 433 to illustrate the connectivity between the reconfigurable processing elements in the systolic array 400. However, the systolic array may include more than nine reconfigurable processing elements, if desired.

The systolic array 400 is suitable for performing matrix multiplication of a first matrix (e.g., matrix A 110 of FIG. 1) and a second matrix (e.g., matrix B 120 of FIG. 1) to determine a result matrix (e.g., matrix C 130 of FIG. 1). The reconfigurable processing elements 411, 412, 413, 421, 422, 423, 431, 432, 433 are configurable for operating in a weight stationary mode or in an output stationary mode.

In the output stationary mode, the first matrix may be streamed into the systolic array 400 from the left (i.e., first into reconfigurable processing elements 411, 421, and 431), whereby the first, second, and third rows of the first matrix are streamed into the first, second, and third rows of the systolic array 400, respectively. The second matrix may be streamed into the systolic array 400 from the top (i.e., first into reconfigurable processing elements 411, 412, and 413), whereby the first, second, and third columns of the second matrix are streamed into the first, second, and third columns of the systolic array 400, respectively.

Consider the scenario in which every reconfigurable processing element stores the incoming signal in a register and produces the signal at the output after one clock cycle. For example, reconfigurable processing element 422 may send the signal received via connection 441 from reconfigurable processing element 421 one clock cycle later to reconfigurable processing element 423 via connection 443. Similarly, reconfigurable processing element 422 may send the signal received via connection 442 from reconfigurable processing element 412 one clock cycle later to reconfigurable processing element 432 via connection 444. In this scenario, the input from the top into reconfigurable processing elements 412 respectively 413 may be delayed by one, respectively two, clock cycles compared to the input from the top into reconfigurable processing element 411. Similarly, the input from the left into reconfigurable processing elements 421 respectively 431 may be delayed by one, respectively two, clock cycles compared to the input from the left into reconfigurable processing element 411.

In the weight stationary mode, the first matrix may be streamed into the systolic array 400 from the left (i.e., first into reconfigurable processing elements 411, 421, and 431). As an example, the first, second, and third columns of the first matrix may be streamed into the first, second, and third rows of the systolic array 400, respectively. The second matrix is stored in the internal registers of the reconfigurable processing elements. In the example, the first, second, and third columns of matrix B may be stored in the internal registers of the first, second, and third columns of the systolic array 400, respectively.

For example, elements b₁₁, b₂₁, and b₃₁ may be stored in reconfigurable processing elements 411, 421, and 431, respectively, elements b₁₂, b₂₂, and b₃₂ may be stored in reconfigurable processing elements 412, 422, and 432, respectively, and elements b₁₃, b₂₃, and b₃₃ may be stored in reconfigurable processing elements 413, 423, and 433, respectively, whereas elements a₁₁, a₂₁, and a₃₁ may successively be streamed into reconfigurable processing elements 411, 412, and 413, respectively, elements a₁₂, a₂₂, and a₃₂ may successively be streamed into reconfigurable processing elements 421, 422, and 423, respectively, and elements a₁₃, a₂₃, and a₃₃ may successively be streamed into reconfigurable processing elements 431, 432, and 433, respectively. Thus, in this example, reconfigurable processing element 431 may successively output elements c₁₁, c₂₁, and c₃₁ of the result matrix, reconfigurable processing element 432 may successively output elements c₁₂, c₂₂, and c₃₂ of the result matrix, and reconfigurable processing element 433 may successively output elements c₁₃, c₂₃, and c₃₃ of the result matrix.

FIG. 5A is a diagram of an illustrative processing element 500 operating in an output stationary mode. As shown, the processing element 500 includes a multiplier circuit 510, an adder circuit 520, and an internal register 530. The adder circuit 520 and the internal register 530 may form an accumulator circuit.

The processing element 500 has first and second input ports and first and second output ports. Connection 542 may couple the first input port with the first output port, and connection 541 may couple the second input port with the second output port. Respective delay registers in connections 541 and 542 have been omitted for simplicity of the representation.

Illustratively, the processing element 500 may receive an element of a matrix A at the first input port and transmit the element of matrix A via connection 542 to the multiplier circuit 510 and to the first output port. Similarly, the processing element 500 may receive an element of matrix B at the second input port and transmit the element of matrix B via connection 541 to the multiplier circuit 510 and to the second output port.

Multiplier circuit 510 generates a product of the element of matrix A and the element of matrix B and transmits the product via connection 543 to the adder circuit 520. The adder circuit 520 generates a sum of the product and a partial result matrix element stored in internal register 530 received via connection 545. The sum is transmitted via connection 544 to the internal register 530, where the sum is stored as a new partial result matrix element.

For example, the processing element 500 may receive K elements of the first row of matrix A at the first input port and K elements of the first column of matrix B at the second input port. The internal register 530 is initialized to zero and stores the element in the first row and the first column of the result matrix C after K iterations. Thus:

$$\\ \begin{matrix}{C}_{11} = {\sum }_{k = 1}^{K} ( {a}_{1 k} {b}_{k 1} ) & ( 2 )\end{matrix}$$

The element in the first row and the first column of the result matrix c₁₁ is output from the internal register 530 of the processing element 500 at the end of the matrix multiplication of the first row of matrix A with the first column of matrix B.

FIG. 5B is a diagram of an illustrative processing element 550 operating in a weight stationary mode. As shown, the processing element 550 includes a multiplier circuit 510, an adder circuit 520, and an internal register 560.

The processing element 550 has first and second input ports and first and second output ports. Connection 542 may couple the first input port with the first output port and multiplier circuit 510. Connection 561 may couple the second input port with the adder circuit 520, and connection 564 may couple the adder circuit 520 with the second output port. Respective delay registers in connections 541 and 564 have been omitted for simplicity of the representation.

During a load phase, an element of matrix B may be loaded into the internal register 560. The element of matrix B may be transmitted via connection 565 to the multiplier circuit. Illustratively, the processing element 550 may receive an element of a matrix A at the first input port and transmit the element of matrix A via connection 542 to the multiplier circuit 510 and to the first output port. The processing element 550 may receive a partially determined element of the result matrix at the second input port and transmit the partially determined element of the result matrix via connection 561 to the adder circuit 520.

Multiplier circuit 510 generates a product of the element of matrix A and the element of matrix B and transmits the product via connection 543 to the adder circuit 520. The adder circuit 520 generates a sum of the product and the partially determined element of the result matrix. The sum is transmitted via connection 564 to the second output port.

For example, the processing element 550 may store an element of the first column of matrix B in the internal register 560 and receive M elements of the first column of matrix A at the first input port. In this example, the partially determined elements of the first column of the result matrix may be successively output from the processing element 550 at the second output port.

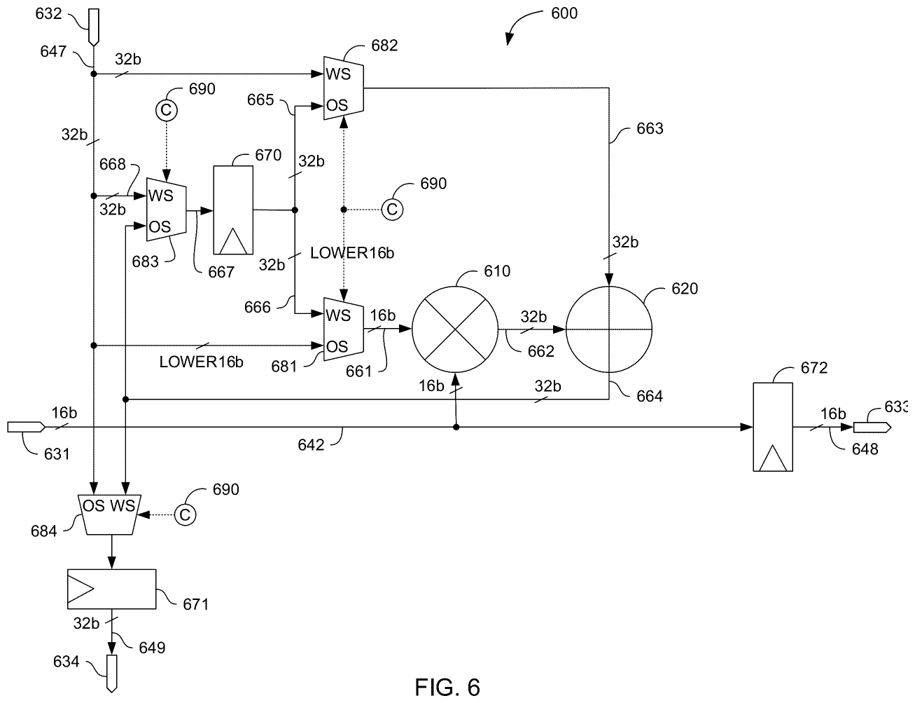

FIG. 6 is a diagram of an illustrative reconfigurable processing element 600 for a systolic array (e.g., systolic array 400 of FIG. 4) that is configurable for multiplying a first matrix (e.g., matrix A 110 of FIG. 1) with a second matrix (e.g., matrix B 120 of FIG. 1) to determine a result matrix (e.g., matrix C 130 of FIG. 1) in a weight stationary mode or in an output stationary mode.

The reconfigurable processing element 600 includes first and second input ports 631, 632, first and second multiplexer circuitry 681, 682, an internal register 670, a multiplier circuit 610, and an adder circuit 620.

The multiplier circuit 610 generates a product of a number of the first matrix received from the first input port 631 and a number of the second matrix received from the first multiplexer circuitry 681 (e.g., via connection 661), whereby the first multiplexer circuitry 681 routes the number of the second matrix from the internal register 670 to the multiplier circuit 610 in the weight stationary mode and from the second input port 632 to the multiplier circuit 610 in the output stationary mode based on a control signal 690.

In some implementations, the control signal 690 may be an external signal that the reconfigurable processing element 600 receives at an additional input port. In other implementations, a configuration storage circuit may store the control signal 690 inside the reconfigurable processing element 600. The control signal 690 may be indicative of whether the reconfigurable processing circuit 600 is configured to operate in the weight stationary mode or the output stationary mode and control the selection of the first and second multiplexer circuitries 681, 682 accordingly.

The adder circuit 620 generates a sum of the product received from the multiplier circuit 610 (e.g., via connection 662) and a number of a partially determined element of the result matrix received from the second multiplexer circuitry 682, whereby the second multiplexer circuitry 682 routes the number of the partially determined element of the result matrix from the second input port 632 to the adder circuit 620 in the weight stationary mode and from the internal register 670 to the adder circuit 620 in the output stationary mode based on the control signal 690.

Illustratively, the reconfigurable processing element may include output port 633 and output register 672 that is coupled to the output port 633, for example via connection 648. Output register 672 may receive the number of the first matrix from the first input port 631, for example via connection 642. Connection 642 may also provide the number of the first matrix from the first input port 631 to the multiplier circuit 610.

As shown in FIG. 6, the reconfigurable processing element 600 may include multiplexer circuitry 684 that provides as a selected signal the sum from the adder circuit 620 in the weight stationary mode and the number of the second matrix from the second input port 632 in the output stationary mode based on the control signal 690. For example, the multiplexer circuitry 684 may receive the sum from the adder circuit 620 via connection 664 in the weight stationary mode and the number of the second matrix from the second input port 632 via connection 647 in the output stationary mode.

By way of example, the reconfigurable processing element 600 may include output port 634 and output register 671 that is coupled to the output port 634. Output register 671 may receive the selected signal from multiplexer circuitry 684, for example via connection 649.

Illustratively, the reconfigurable processing element 600 may include multiplexer circuitry 683 coupled to the internal register 670, for example via connection 667. The multiplexer circuitry 683 routes the number of the second matrix from the second input port 632 to the internal register 670 in the weight stationary mode (e.g., via connections 647, 668) and the sum from the adder circuit 620 to the internal register 670 in the output stationary mode (e.g., via connection 664) based on the control signal 690. Thus, in the output stationary mode, the internal register 670 stores an accumulated number of the result matrix, whereas in the weight stationary mode, the internal register 670 stores a number of the second matrix.

In some implementations, the number of the first matrix, the number of the second matrix, and the accumulated number of the result matrix may have the same data format. For example, all three numbers may have one of the data formats half-precision floating-point (FP16), single-precision floating-point (FP32), double-precision floating-point (FP64), brain floating-point (BF16 or BFLOAT16), or tensor-float 32 (TF32), if desired. In these implementations, the multiplier circuit 610 may multiply the multiplicands and normalize the result to the data format of the multiplicands as part of generating the product. Similarly, the adder circuit 620 may add the summands and normalize the result to the data format of the summands as part of generating the sum.

In other implementations, the number of the first matrix, the number of the second matrix, and the accumulated number of the result matrix may have a different data format. As an example, the numbers of the first and second matrices may both have a BF16 format, and the accumulated number of the result matrix may have a TF32 format. As another example, the numbers of the first and second matrices may both have a TF32 format, and the accumulated number of the result matrix may have a FP32 format. As yet another example, the numbers of the first and second matrices may both have a BF16 format, and the accumulated number of the result matrix may have a FP32 format.

For the purpose of simplifying the discussion and without loss of generality, consider the scenario of FIG. 6 in which the numbers of the first and second matrices are encoded using 16 bits (e.g., having data format BF16) and in which the accumulated number of the result matrix is encoded using 32 bits (e.g., having data format FP32). In this scenario, the multiplier circuit 610 may receive the numbers of the first and second matrices that are encoded using 16 bits and generate a product that has 32 bits, whereas the adder circuit may receive two 32-bit numbers and generate a sum that has 32 bits. Thus, the first input port 631 has a first bit width (e.g., 16 bits) and the second input port has a second bit width (e.g., 32 bits) so that the second bit width is at least twice as large as the first bit width.

The number of the second matrix is received at the second input port 632 in the output stationary mode. As an example, the number of the second matrix may use the least significant bits of the second bit width. As another example, the number of the second matrix may use the most significant bits of the second bit width.

Illustratively, the multiplexer circuitries 681 and 682 may include a plurality of two-input multiplexers that are each controlled by the control signal 690. In some implementations, the second multiplexer circuitry 682 may include at least twice as many two-input multiplexers as the first multiplexer circuitry 681. As an example, the first multiplexer circuitry 681 may include 16 two-input multiplexers to select between the 16 bits of the number of the second matrix stored in the internal register in the weight stationary mode and the 16 bits of the number of the second matrix received from input port 632 in the output stationary mode, and the second multiplexer circuitry 682 may include 32 two-input multiplexers to select between the 32 bits of the accumulated number of the result matrix stored in the internal register 670 in the output stationary mode and the 32 bits of the accumulated number of the result matrix received from input port 632 in the weight stationary mode.

In some implementations, the internal register 670 may include a plurality of one-bit registers. In the scenario in which the numbers of the first and second matrices are encoded using 16 bits and in which the accumulated number of the result matrix is encoded using 32 bits, the internal register 670 has 32 one-bit registers so that the internal register 670 can store the accumulated number of the result matrix from the adder circuit 620 in the output stationary mode. The internal register 670 may provide the accumulated number of the result matrix via connection 665, multiplexer circuitry 681, and connection 663 to the adder circuit 620.

However, in the weight stationary mode, the internal register 670 stores only the 16 bits of the number of the second matrix received from the second input port 632. Thus, the number of the second matrix is stored in at most half of the 32 one-bit registers of the internal register 670 in the weight stationary mode. The internal register 670 may provide the number of the second matrix via the lower 16 bits of connection 666 to the multiplier circuit 610.

Illustratively, the output registers 671, 672 may include a plurality of one-bit registers. In the scenario in which the numbers of the first and second matrices are encoded using 16 bits and in which the accumulated number of the result matrix is encoded using 32 bits, output register 672 has 16 one-bit registers, and output register 671 has 32 one-bit registers.

As mentioned above, in the output stationary mode, the multiplexer circuitry 683 routes the number of the second matrix from the second input port 632 via connections 647 and 668, multiplexer circuitry 683 and connection 667 to the internal register 670 during a load phase (e.g., before the numbers of the first matrix are streamed into the first input port 631). However, in the weight stationary mode, input port 632 receives the accumulated number of the result matrix from another reconfigurable processing element, which is also routed via connections 647 and 668, multiplexer circuitry 683, and connection 667 to the internal register 670 during a multiplication phase (e.g., while the numbers of the first matrix are streamed into the first input port 631). Thus, the internal register 670 is enabled for receiving the number of the second matrix in the weight stationary mode only during the load phase.

Turning back now to the systolic array 400 of FIG. 4 that is suitable for performing matrix multiplication of a first matrix and a second matrix to determine a result matrix. As shown in FIG. 4, the systolic array 400 includes a plurality of reconfigurable processing elements 411, 412, 413, 421, 422, 423, 431, 432, 433 that are configurable for operating in a weight stationary mode or in an output stationary mode.

In the systolic array 400, each one of a first 412, second 421, third 422, fourth 423, and fifth 432 reconfigurable processing element of the plurality of reconfigurable processing elements includes first and second input ports (e.g., input ports 631, 632 of FIG. 6), first and second multiplexer circuitry (e.g., multiplexer circuitry 681, 682 of FIG. 6), an internal register (e.g., register 670 of FIG. 6), a multiplier circuit (e.g., multiplier circuit 610 of FIG. 6), and an adder circuit (e.g., adder circuit 620 of FIG. 6). In the third reconfigurable processing element 422, the multiplier circuit generates a product of a number of the first matrix received from the first input port and a number of the second matrix received from the first multiplexer circuitry, whereby the first multiplexer circuitry routes the number of the second matrix from the internal register to the multiplier circuit in the weight stationary mode and from the second input to the multiplier circuit in the output stationary mode based on a control signal.

Furthermore, in the third reconfigurable processing element 422, the adder circuit generates a sum of the product received from the multiplier circuit and a number of a partially determined element of the result matrix received from the second multiplexer circuitry, whereby the second multiplexer circuitry routes the number of the partially determined element of the result matrix from the second input port to the adder circuit in the weight stationary mode and from the internal register to the adder circuit in the output stationary mode based on the control signal.

Illustratively, each one of the first 412, second 421, third 422, fourth 423, and fifth 432 reconfigurable processing elements of the systolic array 400 may include first and second output ports (e.g., output ports 633, 634 of FIG. 6), first and second output registers (e.g., output registers 672, 671 of FIG. 6), and third multiplexer circuitry (e.g., multiplexer circuitry 684 of FIG. 6). In the third reconfigurable processor circuit 422, the first output register may be coupled to the first output port and receive the number of the first matrix from the first input port, the second output register may be coupled to the second output port, and the third multiplexer circuitry may route the sum from the adder circuit to the second output register in the weight stationary mode and the number of the second matrix from the second input port to the second output register in the output stationary mode based on the control signal.

By way of example, the first input port (e.g., input port 631 of FIG. 6) of the third reconfigurable processing element 422 may be coupled to the first output port (e.g., output port 633 of FIG. 6) of the second reconfigurable processing element 421, the second input port (e.g., input port 632 of FIG. 6) of the third reconfigurable processing element 422 may be coupled to the second output port (e.g., output port 634 of FIG. 6) of the first reconfigurable processing element 412, the first output port (e.g., output port 633 of FIG. 6) of the third reconfigurable processing element 422 may be coupled to the first input port (e.g., input port 631 of FIG. 6) of the fourth reconfigurable processing element 423, and the second output port (e.g., output port 634) of the third reconfigurable processing element 422 may be coupled to the second input port (e.g., input port 632 of FIG. 6) of the fifth reconfigurable processing element 432.

Illustratively, each one of the first 412, second 421, third 422, fourth 423, and fifth 432 reconfigurable processing elements of the systolic array 400 may include third multiplexer circuitry (e.g., multiplexer circuitry 683 of FIG. 6) coupled to the internal register. In the third reconfigurable processing element 422, the third multiplexer circuitry may route the number of the second matrix from the second input port to the internal register in the weight stationary mode and the sum from the adder circuit to the internal register in the output stationary mode based on the control signal. However, the internal register may be enabled for receiving the number of the second matrix in the weight stationary mode only during a load phase.

In some implementations, in each one of a first 412, second 421, third 422, fourth 423, and fifth 432 reconfigurable processing element of the systolic array 400, the first input port may have a first bit width and the second input port a second bit width that is at least twice as large as the first bit width. If desired, the second multiplexer circuitry in the reconfigurable processing elements 412, 421, 422, 423, 432 may include at least twice as many two input multiplexers as the first multiplexer circuitry.

As mentioned above, depending on the dimensions of the first and second matrices, depending on the configuration parameters of the systolic array (e.g., the architecture of the reconfigurable processing elements and/or the connectivity of the reconfigurable processing elements in the systolic array) as well as depending on the energy and performance parameters related to executing predetermined operations on the systolic array including operations that involve external interfaces such as memory interfaces of the systolic array, operating in weight stationary mode may be more efficient than operating in output stationary mode or vice versa.

Therefore, it is desirable to provide a compiler tool for selecting between executing a matrix multiplication operation in a weight stationary mode or in an output stationary mode on a systolic array with reconfigurable processing elements

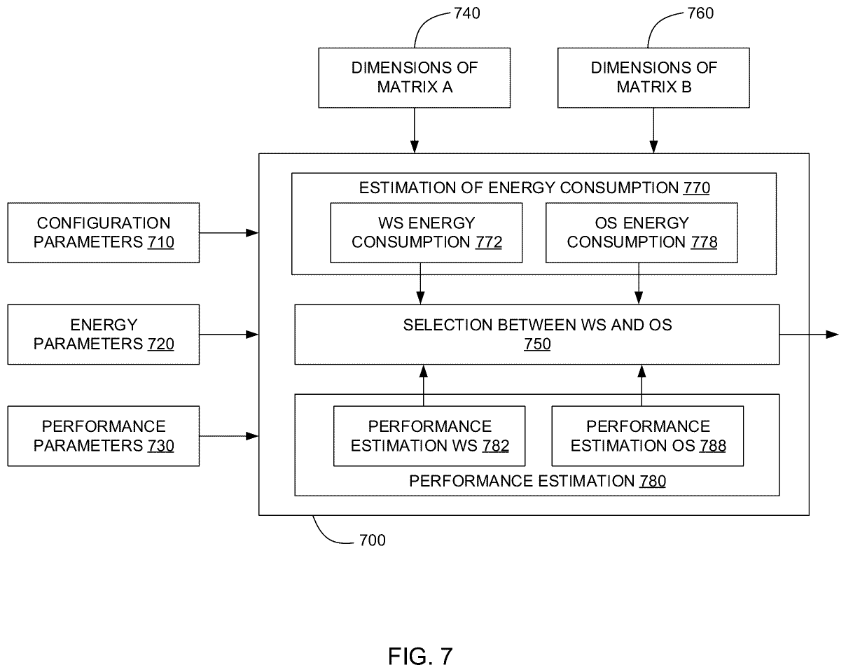

FIG. 7 is a diagram of an illustrative compiler tool 700 for selecting between executing a matrix multiplication operation in a weight stationary mode or in an output stationary mode on a systolic array with reconfigurable processing elements (e.g., on systolic array 400 of FIG. 4 having reconfigurable processing elements 600 of FIG. 6). The matrix multiplication operation includes a multiplication of a first matrix (e.g., matrix A of FIG. 1) with a second matrix (e.g., matrix B of FIG. 1) to determine a result matrix (e.g., matrix C of FIG. 1).

As shown in FIG. 7, the compiler tool 700 receives configuration parameters 710 of the systolic array, energy parameters 720 related to executing predetermined operations on the systolic array, and performance parameters 730 related to executing the predetermined operations on the systolic array.

Illustratively, the systolic array may be coupled to external memory, and the configuration parameters 710 of the systolic array may include a number of rows of reconfigurable processing elements in the systolic array, a number of columns of reconfigurable processing elements in the systolic array, a number of input memory blocks in the systolic array and a size of one such input memory block, a number of output memory blocks in the systolic array and a size of one output memory block, and/or a bandwidth for transmitting data to and receiving data from the external memory. If desired, the configuration parameters 710 may include a width and a height of the systolic array.

By way of example, the systolic array may include compute units and memory units, and the energy parameters 720 related to executing predetermined operations on the systolic array may include a first energy consumption parameter related to executing a multiply-accumulate operation in the compute units, a second energy consumption parameter related to accessing a memory unit of the memory units, a third energy consumption parameter related to accessing the external memory, and/or a fourth energy consumption parameter related to moving a bit of data over a predetermined distance on the systolic array.

Illustratively, the performance parameters 730 may include a latency for executing one cycle of computation (e.g., the latency of one multiply-accumulate operation in a reconfigurable processing element), an operating frequency of the systolic array, and/or a data rate for communicating with the external memory.

The compiler tool 700 is further configured to receive the dimensions 740 of the first matrix (e.g., matrix A) and the dimensions 760 of the second matrix (e.g., matrix B). For example, the compiler tool may receive the number of rows M and the number of columns K of the first matrix and the number of rows K and the number of columns N of the second matrix. If desired. In this example, the result matrix has M rows and N columns.

Illustratively, the compiler tool 700 may determine the storage size of the first matrix, the second matrix, and the result matrix based on the respective dimensions and the storage size of each element. As an example, the elements of the first and second matrices may be encoded using 16 bits (e.g., having data format BF16) and the elements of the result matrix may be encoded using 32 bits (e.g., having data format FP32). In this example, the storage size of the first matrix may be determined as M×K×2 bytes, the storage size of the second matrix as K×N×2 bytes, and the storage size of the result matrix as M×N×4 bytes. As another example, the elements of the first and second matrices may be encoded using 32 bits (e.g., having data format FP32) and the elements of the result matrix may be encoded using 64 bits (e.g., having data format FP64). In this example, the storage size of the first matrix may be determined as M×K×4 bytes, the storage size of the second matrix as K×N×4 bytes, and the storage size of the result matrix as M×N×8 bytes. In some implementations, the compiler tool 700 may receive the storage size of the first matrix, the second matrix, and the result matrix as input parameters.

The compiler tool 700 may include a tool for estimation of energy consumption 770 and a tool for performance estimation 780. The tool for estimation of energy consumption 770 may include a tool for estimation of weight stationary (WS) mode energy consumption 772 and a tool for estimation of output stationary (OS) mode energy consumption 778. The tool for estimation of weight stationary energy consumption 772 of compiler tool 700 is configured to estimate a first energy consumption of executing the matrix multiplication operation on the systolic array in the weight stationary mode based on the energy parameters, the configuration parameters, and the first and second dimensions.

Illustratively, the tool for estimation of weight stationary energy consumption 772 may estimate different portions of the first energy consumption and add the different estimated portions of the first energy consumption to estimate the energy consumption of executing the matrix multiplication operation in the weight stationary mode. A first portion of the first energy consumption may be caused by the multiply-accumulate operations of the matrix multiplication operation in the reconfigurable processing elements. For example, the tool for estimation of weight stationary energy consumption 772 may multiply the total number of multiply-accumulate operations with the first energy consumption parameter related to executing a multiply-accumulate operation in the compute units to estimate the first portion of the energy consumption.

A second portion of the energy consumption may be caused by the data that is written to and read from the memory units. For example, the tool for estimation of weight stationary energy consumption 772 may determine a data quantity that is written to and read from the memory units and multiply this data quantity with a second energy consumption parameter related to accessing a memory unit of the memory units.

A third portion of the energy consumption may be caused by accessing the external memory. For example, the tool for estimation of weight stationary energy consumption 772 may determine a transferred quantity of data to and from the external memory and multiply this transferred quantity of data with a third energy consumption parameter related to accessing the external memory.

A fourth portion of the energy consumption may be caused by moving the data between the memory units and the compute units. For example, the tool for estimation of weight stationary energy consumption may estimate the fourth portion of the energy consumption based on the data quantity written to and read from the memory units, the width and the height of the systolic array, and the fourth energy consumption parameter related to moving a bit of data over a predetermined distance on the systolic array.

A fifth portion of the energy consumption may be caused by moving the data between inputs of the systolic array and the memory units. For example, the tool for estimation of weight stationary energy consumption may estimate the fifth portion of the energy consumption based on the transferred quantity of data, the width and the height of the systolic array, and the fourth energy consumption parameter related to moving a bit of data over a predetermined distance on the systolic array.

The tool for estimation of OS energy consumption 778 of compiler tool 700 is configured to estimate a second energy consumption of executing the matrix multiplication operation on the systolic array in the output stationary mode based on the energy parameters, the configuration parameters, and the first and second dimensions.

Illustratively, the tool for estimation of output stationary energy consumption 778 may estimate different portions of the second energy consumption and add the different estimated portions of the second energy consumption to estimate the energy consumption of executing the matrix multiplication operation in the output stationary mode. A first portion of the second energy consumption may be caused by the multiply-accumulate operations of the matrix multiplication operation in the reconfigurable processing elements. For example, the tool for estimation of output stationary energy consumption 778 may multiply the total number of multiply-accumulate operations with the first energy consumption parameter related to executing a multiply-accumulate operation in the compute units to estimate the first portion of the energy consumption.

A second portion of the energy consumption may be caused by the data that is written to and read from the memory units. For example, the tool for estimation of output stationary energy consumption 778 may determine a data quantity that is written to and read from the memory units and multiply this data quantity with a second energy consumption parameter related to accessing a memory unit of the memory units.

A third portion of the energy consumption may be caused by accessing the external memory. For example, the tool for estimation of output stationary energy consumption 778 may determine a transferred quantity of data to and from the external memory and multiply this transferred quantity of data with a third energy consumption parameter related to accessing the external memory.

A fourth portion of the energy consumption may be caused by moving the data between the memory units and the compute units. For example, the tool for estimation of output stationary energy consumption may estimate the fourth portion of the energy consumption based on the data quantity written to and read from the memory units, the width and the height of the systolic array, and the fourth energy consumption parameter related to moving a bit of data over a predetermined distance on the systolic array.

A fifth portion of the energy consumption may be caused by moving the data between inputs of the systolic array and the memory units. For example, the tool for estimation of output stationary energy consumption may estimate the fifth portion of the energy consumption based on the transferred quantity of data, the width and the height of the systolic array, and the fourth energy consumption parameter related to moving a bit of data over a predetermined distance on the systolic array.

The tool for performance estimation 780 may include a tool for performance estimation of the weight stationary (WS) mode 782 and a tool for performance estimation of the output stationary (OS) mode 788. The tool for performance estimation of the weight stationary mode 782 of compiler tool 700 is configured to estimate a first performance number of executing the matrix multiplication operation on the systolic array in the weight stationary mode based on the performance parameters, the configuration parameters, and the first and second dimensions of the first and second matrices.

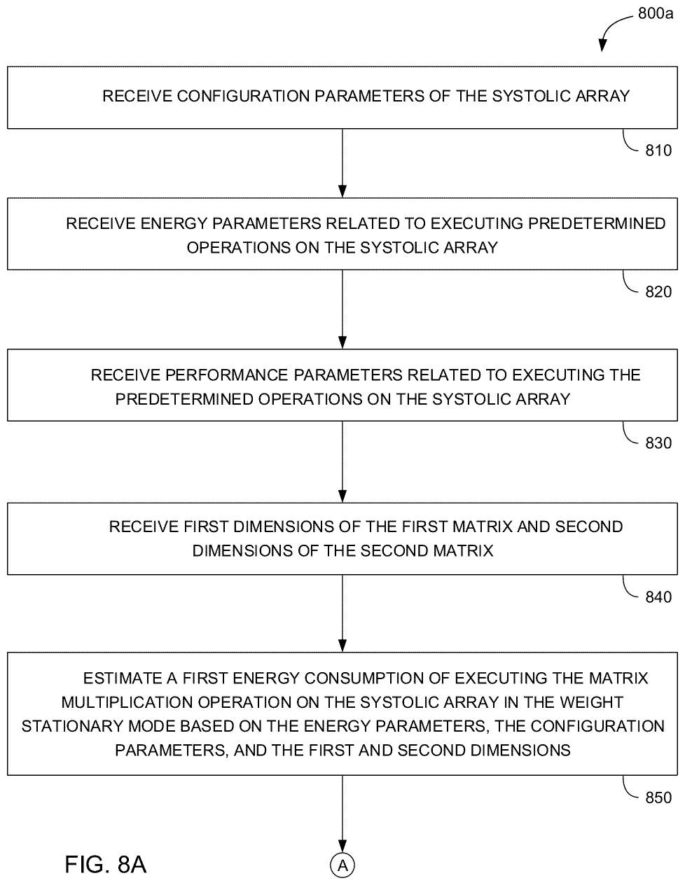

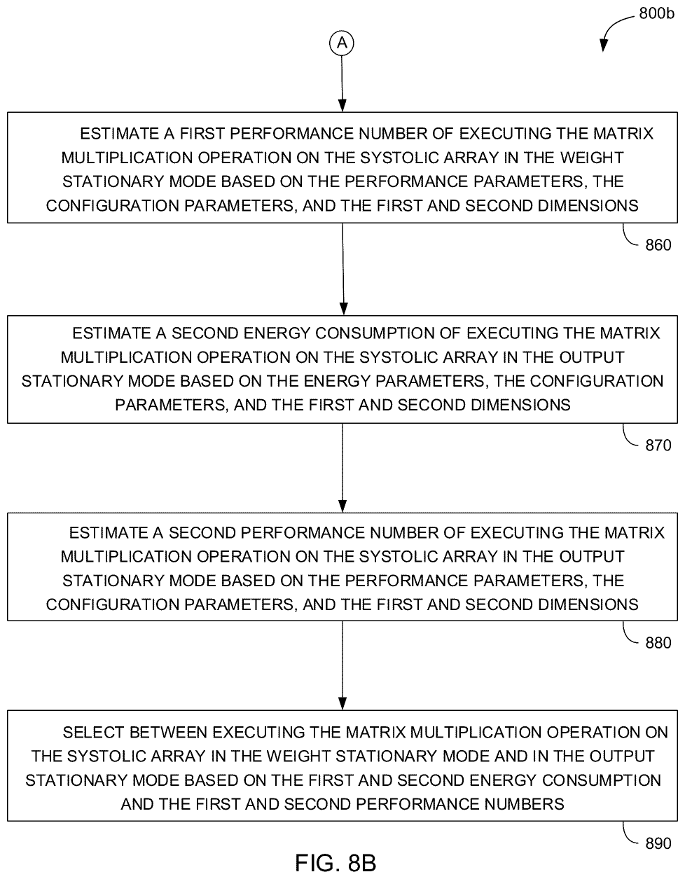

Illustratively, for estimating the first performance number of executing the matrix multiplication operation on the systolic array in the weight stationary mode, the tool for performance estimation of the weight stationary mode 782 of compiler 700 may be configured to determine a first number of row iterations for executing the matrix multiplication operation on the systolic array in the weight stationary mode based on the second number of rows and the number of rows of reconfigurable processing elements, to determine a first number of column iterations for executing the matrix multiplication operation on the systolic array in the weight stationary mode based on the second number of columns and the number of columns of reconfigurable processing elements, and to determine a first transferred quantity of data that is transferred between the external memory and the memory units for executing the matrix multiplication operation on the systolic array in the weight stationary mode, which is further described with reference to operations 850 and 860 of FIGS. 8A and 8B.

For example, the tool for performance estimation of the weight stationary mode 782 of compiler 700 may determine the first number of row iterations (ri1) as the second number of rows (e.g., K) divided by the number of rows of reconfigurable processing elements (R), and the result rounded up to the next integer value (i.e., ri1=ceil (K/R)).

Illustratively, the tool for performance estimation of the weight stationary mode 782 of compiler 700 may determine the first number of column iterations (ci1) as the second number of columns (e.g., N) divided by the number of columns of reconfigurable processing elements (C), and the result rounded up to the next integer value (i.e., ci1=ceil (N/C)).

For estimating the first performance number of executing the matrix multiplication operation on the systolic array in the weight stationary mode, the tool for performance estimation of the weight stationary mode 782 of compiler 700 may further be configured to determine a first computation latency (V_WS1) as a product of the first number of row iterations (ri1), the first number of column iterations (ci1), and the first number of rows (M), divided by the operating frequency (f) (i.e., V_WS1=(ri1×ci1×M)/f), to determine a first data access latency (V_WS2) as a quotient of the first transferred quantity of data (sizeof_1^{st}_trans) divided by the bandwidth for transmitting data to and receiving data from the external memory (bw) (i.e., V_WS2=sizeof_1^{st}_trans/bw), and to determine a total latency (V_WS) of the matrix multiplication operation in the weight stationary mode by selecting the greater of the first computation latency and the first data access latency (i.e., V_WS=max (V_WS1, V_WS2)).

The tool for performance estimation of the output stationary (OS) mode 788 of compiler tool 700 is configured to estimate a second performance number of executing the matrix multiplication operation on the systolic array in the output stationary mode based on the performance parameters, the configuration parameters, and the first and second dimensions.

Illustratively, for estimating the second performance number of executing the matrix multiplication operation on the systolic array in the output stationary mode, the tool for performance estimation of the output stationary mode 788 of compiler 700 may be configured to determine a second number of row iterations for executing the matrix multiplication operation on the systolic array in the output stationary mode based on the first number of rows and the number of rows of reconfigurable processing elements, to determine a second number of column iterations for executing the matrix multiplication operation on the systolic array in the output stationary mode based on the second number of columns and the number of columns of reconfigurable processing elements, and to determine a second transferred quantity of data that is transferred between the external memory and the memory units for executing the matrix multiplication operation on the systolic array in the output stationary mode, which is further which is further described with reference to operations 850 and 860 of FIGS. 8A and 8B.

For example, the tool for performance estimation of the output stationary mode 788 of compiler 700 may determine the second number of row iterations (ri2) as the first number of rows (e.g., M) divided by the number of rows of reconfigurable processing elements (R), and the result rounded up to the next integer value (i.e., ri2=ceil (M/R)).

Illustratively, the tool for performance estimation of the output stationary mode 788 of compiler 700 may determine the second number of column iterations (ci2) as the second number of columns (e.g., N) divided by the number of columns of reconfigurable processing elements (C), and the result rounded up to the next integer value (i.e., ci2=ceil (N/C)).

For estimating the second performance number of executing the matrix multiplication operation on the systolic array in the output stationary mode, the tool for performance estimation of the output stationary mode 788 of compiler 700 may further be configured to determine a second computation latency (CL2) as a product of the second number of row iterations, the second number of column iterations, and the second number of rows, divided by the operating frequency (i.e., CL2=(ri2×ci2×K)/f), to determine a second data access latency (DL2) as a quotient of the second transferred quantity of data (tq2) divided by the bandwidth for transmitting data to and receiving data from the external memory (bw) (i.e., DL2=tq2/bw), and to determine a total latency (TL_OS) of the matrix multiplication operation in the output stationary mode by selecting the greater of the second computation latency and the second data access latency (i.e., TL_OS=max (CL2, DL2)).

The compiler tool 700 may include a selection tool 750. The selection tool 750 of compiler tool 700 may be configured to select between executing the matrix multiplication operation on the systolic array in the weight stationary mode and in the output stationary mode based on the first and second energy consumption and the first and second performance numbers.

Illustratively, the selection tool 750 of compiler tool 700 may be configured to determine a first value of executing the matrix multiplication operation in the weight stationary mode on the systolic array based on the first energy consumption and the first performance number, to determine a second value of executing the matrix multiplication operation in the output stationary mode on the systolic array based on the second energy consumption and the second performance number, and to select to execute the matrix multiplication operation in the weight stationary mode or in the output stationary mode based on a comparison of the first and second values.

For example, the selection tool 750 of the compiler 700 may determine the first value as a sum of a first weighted cost of the first energy consumption and the first performance number and the second value as a sum of a second weighted cost of the second energy consumption and the second performance number and determine whether the first weighted cost is lower than the second weighted cost. In response to determining that the first weighted cost is lower than the second weighted cost, the selection tool 750 may select to execute the matrix multiplication operation in the weight stationary mode, and in response to determining that the second weighted cost is lower than the first weighted cost, the selection tool 750 may select to execute the matrix multiplication operation in the output stationary mode.

FIG. 8A is a flowchart 800a showing a first portion of illustrative operations 810, 820, 830, 840, 850 that a compiler tool (e.g., compiler tool 700 of FIG. 7) performs for selecting between executing a matrix multiplication operation in a weight stationary mode or in an output stationary mode on a systolic array with reconfigurable processing elements.

During operation 810, the compiler tool receives configuration parameters of the systolic array. For example, compiler tool 700 of FIG. 7 may receive configuration parameters 710.

Illustratively, the systolic array is coupled to external memory. By way of example, the configuration parameters of the systolic array may include a number of rows of reconfigurable processing elements (R), a number of columns of reconfigurable processing elements (C), a number of input memory blocks, a size of one input memory block, a number of output memory blocks, a size of one output memory block, an operating frequency, and/or a bandwidth for transmitting data to and receiving data from the external memory.

During operation 820, the compiler tool receives energy parameters related to executing predetermined operations on the systolic array. For example, the compiler tool 700 of FIG. 7 may receive energy parameters 720.

Illustratively, the systolic array may include compute units and memory units. By way of example, the compiler tool may receive as energy consumption parameters related to executing predetermined operations on the systolic array a first energy consumption parameter (W1) related to executing a multiply-accumulate operation in the compute units, a second energy consumption parameter (W2) related to accessing a memory unit of the memory units, a third energy consumption parameter (W3) related to accessing the external memory, and a fourth energy consumption parameter (W4) related to moving a bit of data over a predetermined distance on the systolic array.

During operation 830, the compiler tool receives performance parameters related to executing the predetermined operations on the systolic array. For example, the compiler tool 700 of FIG. 7 may receive performance parameters 730.

Illustratively, the compiler tool may receive as performance parameters an operating frequency, a data transfer rate of external memory interfaces of the systolic array, and a bandwidth of these external memory interfaces.

During operation 840, the compiler tool receives first dimensions of the first matrix and second dimensions of the second matrix. For example, the compiler too 700 of FIG. 7 may receive the dimensions of matrix A 740 and the dimensions of matrix B 760.

Consider the scenario in which the first matrix has M rows and K columns and the second matrix has K rows and N columns. In this scenario, the first dimensions may include a first number of rows equal to M and a first number of columns equal to K, and the second dimensions may include a second number of rows equal to K and a second number of columns equal to N.

As mentioned above, the compiler tool may determine the storage size of the first matrix (sizeof_A), the second matrix (sizeof_B), and the result matrix (sizeof_C) based on the respective dimensions and the storage size of each element. As an example, the elements of the first and second matrices may be encoded using 16 bits (e.g., having data format BF16) and the elements of the result matrix may be encoded using 32 bits (e.g., having data format FP32). In this example, the storage size of the first matrix may be determined as sizeof_A=M×K×2 bytes, the storage size of the second matrix as sizeof_b=K×N×2 bytes, and the storage size of the result matrix as sizeof_C=M×N×4 bytes. As another example, the elements of the first and second matrices may be encoded using 32 bits (e.g., having data format FP32) and the elements of the result matrix may be encoded using 64 bits (e.g., having data format FP64). In this example, the storage size of the first matrix may be determined as sizeof_A=M×K×4 bytes, the storage size of the second matrix as sizeof_B=K×N×4 bytes, and the storage size of the result matrix as sizeof_C=M×N×8 bytes. In some implementations, the compiler tool may receive the storage size of the first matrix (sizeof_A), the second matrix (sizeof_B), and the result matrix (sizeof_C) as input parameters.

Illustratively, the compiler tool may determine a total number of multiply-accumulate operations based on the first and second dimensions. In the scenario above, the compiler tool may determine the total number of multiply-accumulate operations as the product of M, K, and N (i.e., M×K×N).

By way of example, the compiler tool may determine a first number of row iterations (ri1) for executing the matrix multiplication operation on the systolic array in the weight stationary mode based on the second number of rows and the number of rows of reconfigurable processing elements and determine a first number of column iterations (ci1) for executing the matrix multiplication operation on the systolic array in the weight stationary mode based on the second number of columns and the number of columns of reconfigurable processing elements.

For example, further consider in the scenario above that the systolic array has R rows and C columns of reconfigurable processing elements. In this scenario, the compiler tool may determine the first number of row iterations as the smallest integer number greater than or equal to the integer division of K by R (i.e., ri1=ceil (K/R)) and the first number of column iterations as the smallest integer number greater than or equal to the integer division of N by C (i.e., ci1=ceil (N/C)).

Illustratively, the compiler tool may determine a second number of row iterations (ri2) for executing the matrix multiplication operation on the systolic array in the output stationary mode based on the first number of rows and the number of rows of reconfigurable processing elements, and determine a second number of column iterations (ci2) for executing the matrix multiplication operation on the systolic array in the output stationary mode based on the second number of columns and the number of columns of reconfigurable processing elements.

For example, in the scenario above, the compiler tool may determine the second number of row iterations as the smallest integer number greater than or equal to the integer division of M by R (i.e., ri2=ceil (M/R)) and the first number of column iterations as the smallest integer number greater than or equal to the integer division of N by C (i.e., ci2=ceil (N/C)).

In some implementations, the first and second matrices are stored in external memory, and the result matrix is written to the external memory upon completion of the matrix multiplication operation. In these implementations, the quantity of data that is read from the external memory and written back to the external memory may have a considerable impact on the selection between executing the matrix multiplication operation in the weight stationary mode or in the output stationary mode.

To determine the quantity of data that is transferred in and out of the external memory, the compiler tool may partition the number of input memory blocks into a first number of input memory blocks for receiving the first matrix and a second number of input memory blocks for receiving the second matrix. Illustratively, the compiler tool may determine a first input buffer size based on multiplying the first number of input memory blocks with the size of one input memory block, determine a second input buffer size based on multiplying the second number of input memory blocks with the size of one input memory block, and determine an output buffer size based on multiplying the number of output memory blocks with the size of one output memory block.

For example, memory units at the left of each row R may be reserved as input memory blocks for receiving data of the first matrix from the external memory, memory units at the top of each column C may be reserved as input memory blocks for receiving data of the second matrix from the external memory, and all other memory units may be reserved as output memory blocks for sending data of the result matrix to the external memory. In the scenario in which the size of one input memory block is equal to IN_MEM and the size of one output memory block is equal to OUT_MEM, the first input buffer size (IN_BUF1) is equal to R×IN_MEM, the second input buffer size (IN_BUF2) is equal to C×IN_MEM, and the output buffer size (OUT_BUF) is equal to (R−1)×(C−1)×OUT_MEM.

Illustratively, the compiler tool may determine a first transferred quantity of data (sizeof_1^{st}_trans) that is transferred between the external memory and the memory units for executing the matrix multiplication operation on the systolic array in the weight stationary mode based at least in part on the first input buffer size, the first storage size, the output buffer size, the third storage size, the first number of row iterations, or the first number of column operations.

By way of example, the compiler tool may determine a tile size of the first matrix based on the first number of rows of the first matrix and the number of rows of reconfigurable processing elements and determine whether the tile size of the first matrix is greater than the first input buffer size (i.e., whether the entire first matrix (sizeof_A) fits into the first input buffer (IN_BUF1) and thus only one data transfer of the first matrix between the external memory and the first input buffers is required or whether the first matrix needs to be loaded more than once and thus more than one data transfer of the first matrix between the external memory and first input buffers is required).

Thus, in response to determining that the tile size is greater than the first input buffer size, the compiler tool may determine a first transferred sub-quantity of data (trans_1) as the first storage size of the first matrix (sizeof_A) times the first number of column iterations (i.e., trans_1=sizeof_A×ci1), and in response to determining that the tile size is not greater than the first input buffer size, the compiler tool may determine the first transferred sub-quantity of data as the first storage size (i.e., trans_1=sizeof_A).

Similarly, the compiler tool may determine whether the third storage size (sizeof_C) is greater than the output buffer size (OUT_BUF). In response to determining that the third storage size is greater than the output buffer size, the compiler tool may determine a second transferred sub-quantity of data (trans_2) as the first number of row iterations times two times the third storage size (i.e., trans_2=ri1×2×sizeof_C), and in response to determining that the third storage size is not greater than the output buffer size, the compiler tool may determine the second transferred sub-quantity of data as the third storage size (i.e., trans_2=sizeof_C).

In the weight stationary mode, the second matrix may be transferred only once from the external memory to the systolic array. Thus, the compiler tool may determine the first transferred quantity of data as a sum of the first and second transferred sub-quantities of data and the second storage size (i.e., sizeof_1^{st}_trans=trans_1+trans_2+sizeof_B).

Illustratively, the compiler tool may determine a second transferred quantity of data (sizeof_2^{nd}_trans) that is transferred between the external memory and the memory units for executing the matrix multiplication operation on the systolic array in the output stationary mode based at least in part on the first input buffer size, the first storage size, the second input buffer size, the second storage size, the second number of row iterations, or the second number of column iterations.

By way of example, the compiler tool may determine a first tile size of the first matrix based on the first number of columns of the first matrix and the number of rows of reconfigurable processing elements and a second tile size of the second matrix based on the second number of rows of the second matrix and the number of columns of reconfigurable processing elements.

Illustratively, the compiler tool may determine whether the first storage size (sizeof_A) is greater than the first input buffer size (IN_BUF1) and whether the second storage size (sizeof_B) is greater than the second input buffer size (IN_BUF2) (i.e., whether the entire first and second matrices fit into the respective input buffers).

In a first scenario, in response to determining that the first storage size is not greater than the first input buffer size and that the second storage size is not greater than the second input buffer size, the compiler tool may determine a first transferred sub-quantity of data (trans_1) as the first storage size (i.e., trans_1=sizeof_A) and a second transferred sub-quantity of data as the second storage size (i.e., trans_2=sizeof_B).

In a second scenario, in response to determining that the first storage size is greater than the first input buffer size and that the second storage size is not greater than the second input buffer size, the compiler tool may determine the second transferred sub-quantity of data as the second storage size (i.e., trans_2=sizeof_B). In this second scenario, the compiler tool may further determine whether the first tile size of the first matrix is greater than the first input buffer size. In response to determining that the first tile size is not greater than the first input buffer size, the compiler tool may determine the first transferred sub-quantity of data as the first storage size times the first number of column iterations (i.e., trans_1=sizeof_A×ri1).

In a third scenario, in response to determining that the first storage size is not greater than the first input buffer size and that the second storage size is greater than the second input buffer size, the compiler tool may determine the first transferred sub-quantity of data as the first storage size (i.e., trans_1=sizeof_A). In this third scenario, the compiler tool may further determine whether the second tile size of the second matrix is greater than the second input buffer size. In response to determining that the second tile size is not greater than the second input buffer size, the compiler tool may determine the second transferred sub-quantity of data as the second storage size times the second number of row iterations (i.e., trans_2=sizeof_B×ri2).

In a fourth scenario, in response to determining that the first storage size is greater than the first input buffer size and that the second storage size is greater than the second input buffer size, the compiler tool may determine whether the first tile size of the first matrix is greater than the first input buffer size and whether the second tile size of the second matrix is greater than the second input buffer size. In this fourth scenario, in response to determining that the first tile size is greater than the first input buffer size and that the second tile size is greater than the second input buffer size, the compiler tool may determine the first transferred sub-quantity of data as the first storage size times the first number of row iterations times the first number of column iterations (i.e., trans_1=sizeof_A×ri1×ci1), and determine the second transferred sub-quantity of data as the second storage size times the second number of row iterations times the second number of column iterations (i.e., trans_2=sizeof_B×ri2×ci2).

In the output stationary mode, the result matrix may be transferred only once from the systolic array to the external memory. Thus, the compiler tool may determine the second transferred quantity of data as a sum of the first and second transferred sub-quantities of data and the third storage size (i.e., sizeof_2^{nd}_trans=trans 1+trans 2+sizeof_C).

During operation 850, the compiler tool estimates a first energy consumption (W_WS) of executing the matrix multiplication operation on the systolic array in the weight stationary mode based on the energy parameters, the configuration parameters, and the first and second dimensions. For example, the compiler tool 700 of FIG. 7 may use the weight stationary energy consumption estimation tool 772 of the estimation of energy consumption tool 770 to estimate the first energy consumption of executing the matrix multiplication operation on the systolic array in the weight stationary mode based on the energy parameters 720, the configuration parameters 710, and the first and second dimensions 740, 760.

Illustratively, the compiler tool may estimate different components of the first energy consumption and sum the different components for estimating the first energy consumption. For example, the compiler tool may estimate a first portion of the first energy consumption (W_WS1) by multiplying the total number of multiply-accumulate operations with the first energy consumption parameter (i.e., W_WS1=M×K×N×W1).

The compiler tool may further determine a data quantity written to and read from the memory units (MU_DQ) as a sum of the first storage size multiplied with the first number of column iterations, the second storage size, and the third storage size multiplied with the first number of row iterations (i.e., MU_DQ=sizeof_A×ci1+sizeof_B+sizeof_C×ri1), and estimate a second portion of the first energy consumption (W_WS2) based on the second energy consumption parameter and the data quantity written to and read from the memory units (i.e., W_WS2=MU_DQ×W2).

By way of example, the compiler tool may estimate a third portion of the first energy consumption (W_WS3) based on the third energy consumption parameter and the first transferred quantity of data (e.g., W_WS3=sizeof_1^{st}_trans×W3).

Illustratively, the compiler tool may estimate a fourth portion of the first energy consumption (W_WS4) based on the data quantity written to and read from the memory units, a width (w) and a height (h) of the systolic array, and the fourth energy consumption parameter. For example, the compiler tool may estimate a movement of data to and from the memory units as (sizeof_A×ci1×w+sizeof_B×h/2+sizeof_C×ri1×h) and multiply the result with W4 to determine W_WS4.

The compiler tool may further estimate a fifth portion of the first energy consumption (W_WS5) based on the first transferred quantity of data, the width and the height of the systolic array, and the fourth energy consumption parameter (e.g., W_WS5=sizeof_1^{st}_trans×w×W4).

Finally, the compiler tool may estimate the first energy consumption based on a sum of the first, second, third, fourth, and fifth portions of the first energy consumption (i.e., W_WS=W_WS1+W_WS2+W_WS3+W_WS4+W_WS5).

FIG. 8B is a flowchart 800b showing a second portion of illustrative operations 860, 870, 880, 890 that a compiler tool (e.g., compiler tool 700 of FIG. 7) performs for selecting between executing a matrix multiplication operation in a weight stationary mode or in an output stationary mode on a systolic array with reconfigurable processing elements.

During operation 860, the compiler tool estimates a first performance number (V_WS) of executing the matrix multiplication operation on the systolic array in the weight stationary mode based on the performance parameters, the configuration parameters, and the first and second dimensions. For example, the compiler tool 700 of FIG. 7 may use the weight stationary performance estimation tool 782 of the performance estimation tool 780 to estimate the first performance number of executing the matrix multiplication operation on the systolic array in the weight stationary mode based on the performance parameters 730, the configuration parameters 710, and the first and second dimensions 740, 760.

Illustratively, for estimating the first performance number, the compiler tool may determine a first computation latency V_WS1 as a product of the first number of row iterations, the first number of column iterations, and the first number of rows, divided by the operating frequency (i.e., V_WS1=ri1×ci1×M/f). The compiler tool may further determine a first data access latency (V_WS2) as a quotient of the first transferred quantity of data divided by the bandwidth for transmitting data to and receiving data from the external memory (i.e., V_WS2=sizeof_1^{st}_trans/bw).

By way of example, the compiler tool may determine a total latency of the matrix multiplication operation by selecting the greater of the first computation latency and the first data access latency (i.e., V_WS=max (V_WS1, V_WS2)).

During operation 870, the compiler tool estimates a second energy consumption of executing the matrix multiplication operation on the systolic array in the output stationary mode based on the energy parameters, the configuration parameters, and the first and second dimensions. For example, the compiler tool 700 of FIG. 7 may use the output stationary energy consumption estimation tool 778 of the estimation of energy consumption tool 770 to estimate the second energy consumption of executing the matrix multiplication operation on the systolic array in the output stationary mode based on the energy parameters 720, the configuration parameters 710, and the first and second dimensions 740, 760.

Illustratively, the compiler tool may estimate different components of the second energy consumption and sum the different components for estimating the second energy consumption. For example, the compiler tool may estimate a first portion of the second energy consumption (W_OS1) by multiplying the total number of multiply-accumulate operations with the first energy consumption parameter (i.e., W_OS1=M×K×N×W1).

The compiler tool may further determine a data quantity written to and read from the memory units (MU_DQ) as a sum of the first storage size multiplied with the second number of column iterations, the second storage size multiplied with the second number of row iterations, and the third storage size (i.e., MU_DQ=sizeof_A×ci1+sizeof_B×ri2+sizeof_C), and estimate a second portion of the second energy consumption (W_OS2) based on the second energy consumption parameter and the data quantity written to and read from the memory units (i.e., W_OS2=MU_DQ×W2).

By way of example, the compiler tool may estimate a third portion of the second energy consumption (W_OS3) based on the third energy consumption parameter and the second transferred quantity of data (e.g., W_OS3=sizeof_2^{nd}_trans×W3).

Illustratively, the compiler tool may estimate a fourth portion of the second energy consumption (W_OS4) based on the data quantity written to and read from the memory units, a width (w) and a height (h) of the systolic array, and the fourth energy consumption parameter. For example, the compiler tool may estimate a movement of data to and from the memory units as (sizeof_A×ci2×w+sizeof_B×ri2×h+sizeof_C×h/2) and multiply the result with W4 to determine W_OS4.

The compiler tool may further estimate a fifth portion of the second energy consumption (W_OS5) based on the second transferred quantity of data, the width and/or the height of the systolic array, and the fourth energy consumption parameter (e.g., W_OS5=sizeof_2^{nd}_trans×w×W4).

Finally, the compiler tool may estimate the second energy consumption based on a sum of the first, second, third, fourth, and fifth portions of the second energy consumption (i.e., W_OS=W_OS1+W_OS2+W_OS3+W_OS4+W_OS5).

During operation 880, the compiler tool estimates a second performance number (V_OS) of executing the matrix multiplication operation on the systolic array in the output stationary mode based on the performance parameters, the configuration parameters, and the first and second dimensions. For example, the compiler tool 700 of FIG. 7 may use the output stationary performance estimation tool 788 of the performance estimation tool 780 to estimate the second performance number of executing the matrix multiplication operation on the systolic array in the output stationary mode based on the performance parameters 730, the configuration parameters 710, and the first and second dimensions 740, 760.

Illustratively, for estimating the second performance number, the compiler tool may determine a second computation latency V_OS1 as a product of the second number of row iterations, the second number of column iterations, and the second number of rows, divided by the operating frequency (i.e., V_OS1=ri2×ci2×K/f). The compiler tool may further determine a second data access latency (V_OS2) as a quotient of the second transferred quantity of data divided by the bandwidth for transmitting data to and receiving data from the external memory (i.e., V_OS2=sizeof_2^{nd}_trans/bw).

By way of example, the compiler tool may determine a total latency of the matrix multiplication operation by selecting the greater of the second computation latency and the second data access latency (i.e., V_OS=max (V_OS1, V_OS2)).

During operation 890, the compiler tool selects between executing the matrix multiplication operation on the systolic array in the weight stationary mode and in the output stationary mode based on the first and second energy consumption and the first and second performance numbers. For example, the tool for selecting between weight stationary and output stationary mode 750 of compiler tool 700 of FIG. 7 may select between executing the matrix multiplication operation on the systolic array in the weight stationary mode and in the output stationary mode based on the first and second energy consumption estimated by the estimation of energy consumption tool 770 and the first and second performance numbers estimated by the performance estimation tool 780.

Illustratively, for selecting between executing the matrix multiplication operation on the systolic array in the weight stationary mode and the output stationary mode based on the first and second energy consumption and the first and second performance numbers, the compiler tool may determine a first value (Val_WS) based on the first energy consumption and the first performance number, determine a second value (Val_OS) based on the second energy consumption and the second performance number, and select to execute the matrix multiplication operation in the weight stationary mode or in the output stationary mode based on a comparison of the first and second values.

In some implementations, determining the first value may include determining a first weighted cost of the first energy consumption and the first performance number, and determining the second value may include determining a second weighted cost of the second energy consumption and the second performance number. For example, Val_WS=a×V_WS+b×W_WS, and Val_OS=a×V_OS+b×W_OS, where a and b are weights that determine whether the performance or the energy consumption are weighted more, and thus, are given more importance. If desired, the sum of a and b may be one (i.e., a+b=1).

In these implementations, for selecting to execute the matrix multiplication operation in the weight stationary mode or in the output stationary mode based on the comparison of the first and second values, the compiler tool may determine whether the first weighted cost is lower than the second weighted cost. In response to determining that the first weighted cost is lower than the second weighted cost, the compiler tool may select to execute the matrix multiplication operation in the weight stationary mode, whereas in response to determining that the second weighted cost is lower than the first weighted cost, the compiler tool may select to execute the matrix multiplication operation in the output stationary mode.

As an example, consider the scenario in which the first, second, and result matrix each have 4096 rows and 4096 columns (i.e., M=K=N=4096) whereby each element of these matrices is encoded using 2 bytes (e.g., bf16). Thus, the storage sizes of the first, second, and result matrices are sizeof_A=sizeof_B=sizeof_C=33.55 MB.

Consider further that the systolic array has R=960 rows, C=320 columns, a height and width h=w=25 mm, an operating frequency f=2 GHZ, a number of 960 input memory blocks for receiving the first matrix, a number of 320 memory blocks for receiving the second matrix, a number of 305921 output memory blocks, whereby each input memory block and each output memory block has a size IN_MEM=OUT_MEM=512 KB, and a bandwidth for transmitting data to and receiving data from the external memory of 8.6 TB/s.

Consider further that the first energy consumption parameter related to executing a multiply-accumulate operation in the compute units W1=0.59 pJ, the second energy consumption parameter related to accessing a memory unit of the memory units W2=7.5 pJ, the third energy consumption parameter related to accessing the external memory W3=350 pJ, and the fourth energy consumption parameter related to moving a bit of data over a predetermined distance on the systolic array W4=0.21 pJ/mm.

In this scenario, and since M=K=N, the first and second row and column iterations may be determined as:

$$\\ \begin{matrix}ri 1 = ri 2 = ceil ( K / R ) = 5 & ( 1 )\end{matrix}$$

$$\\ \begin{matrix}ci 1 = ci 2 = ceil ( N / C ) = 13 & ( 2 )\end{matrix}$$

The sizes of the input buffers IN_BUF1, IN_BUF2 and the size of the output buffer OUT_BUF may be determined as:

$$\\ \begin{matrix}IN\_BUF 1 = R \times IN\_MEM = 491.52 MB & ( 3 )\end{matrix}$$

$$\\ \begin{matrix}IN\_BUF 2 = C \times IN\_MEM = 163.84 MB & ( 4 )\end{matrix}$$

$$\\ \begin{matrix}OUT\_BUF = ( R - 1 ) \times ( C - 1 ) \times OUT\_MEM = 156.63 GB & ( 5 )\end{matrix}$$

In the weight stationary mode, the first, second, and result matrices fit in the respective input and output buffers whereas in the output stationary mode, the second matrix needs to be reloaded from external memory. Thus, the first and second transferred quantities of data may be determined as:

$$\\ \begin{matrix}sizeof\_ 1 st\_trans = sizeof\_A + sizeof\_B + sizeof\_C = 100.66 MB & ( 6 )\end{matrix}$$

$$\\ \begin{matrix}sizeof\_ 2 nd\_trans = sizeof\_A + sizeof\_B \times ri 2 + sizeof\_C = 234.88 MB & ( 7 )\end{matrix}$$

Since M=K, the first and second row iterations are equal, and thus, the first and second computation latencies are equal and may be determined as:

$$\\ \begin{matrix}V\_WS 1 = V\_OS 1 = ri 1 * M * ci 1 / f = 133 us & ( 8 )\end{matrix}$$

Whereas the data access latencies are different and may be determined as:

$$\\ \begin{matrix}V\_WS 2 = sizeof\_ 1 st\_trans / bw = 12 us & ( 9 )\end{matrix}$$

$$\\ \begin{matrix}V\_OS 2 = sizeof\_ 2 n \_trans / bw = 27 us & ( 10 )\end{matrix}$$

In the present scenario, the total latencies between the weight stationary and output stationary mode are equal since the compute latencies are equal and greater than the data access latencies:

$$\\ \begin{matrix}V\_WS = V\_OS = max ( V\_WS 1 , V\_WS 2 ) = max ( V\_OS 1 , V\_OS 2 ) = 133 us & ( 11 )\end{matrix}$$

Turning now to estimating the different portions of energy consumption. In the present scenario, the first portion of energy consumption in the weight stationary mode is equal to the first portion in the output stationary mode:

$$\\ \begin{matrix}W\_WS 1 = W\_OS 1 = M \times K \times N \times W 1 = 40 mJ & ( 12 )\end{matrix}$$

In the present scenario, the storage sizes of the matrices are equal as well as the row iterations in the weight and output stationary modes. Thus,

$$\\ \begin{matrix}W\_WS 2 = W\_OS 2 = sizeof\_A \times ci 1 + sizeof\_B \times ri 2 + sizeof\_C ) \times W 2 = 0.6 mJ & ( 13 )\end{matrix}$$

The third portion of the energy consumptions may be estimated as follows:

$$\\ \begin{matrix}W\_WS 3 = sizeof\_ 1 st\_trans \times W 3 = 4 mJ & ( 14 )\end{matrix}$$

$$\\ \begin{matrix}W\_OS 3 = sizeof\_ 2 nd\_trans \times W 3 = 10 mJ & ( 15 )\end{matrix}$$

Since in the present scenario, the width equals the height of the chip and row and column iterations as well as the matrix dimensions, their storage sizes, and the data quantities written to and read from the memory units are the same between the weight stationary mode and the output stationary mode, the fourth portion of the energy consumption may be estimated as:

$$\\ \begin{matrix}W\_WS 4 = W\_OS 4 = ( sizeof\_A \times ci 2 \times w + sizeof\_B \times ri 2 \times h + sizeof\_C \times h / 2 ) \times W 4 = 26 mJ & ( 16 )\end{matrix}$$

The compiler tool may further estimate the fifth portion of the energy consumption as:

$$\\ \begin{matrix}W\_WS 5 = sizeof\_ 1 st\_trans \times W 4 = 4 mJ & ( 17 )\end{matrix}$$

$$\\ \begin{matrix}W\_OS 5 = sizeof\_ 2 nd\_trans \times w \times W 4 = 10 mJ & ( 18 )\end{matrix}$$

Thus, the total energy consumption in the weight stationary mode would be estimated to:

$$\\ \begin{matrix}W\_WS = W\_WS 1 + W\_WS 2 + W\_WS 3 + W\_WS 4 + W\_WS 5 = 74.6 mJ & ( 19 )\end{matrix}$$

and the total energy consumption in the output stationary mode would be estimated to:

$$\\ \begin{matrix}W\_OS = W\_OS 1 + W\_OS 2 + W\_OS 3 + W\_OS 4 + W\_OS 5 = 86.6 mJ & ( 20 )\end{matrix}$$

If desired, coefficients of the cost function may be selected to be a=0.6 and b=0.4. Thus, the total cost (Val_WS) of executing the matrix multiplication operation in the weight stationary mode may be determined as:

$$\\ Val\_WS = 0.6 \times 133 + 0.4 \times 74.6 = 109.64$$

and the total cost (Val_OS) of executing the matrix multiplication operation in the output stationary mode may be determined as:

$$\\ Val\_OS = 0.6 \times 133 + 0.4 \times 86.6 = 114.44$$

In the present scenario, the cost of executing the matrix multiplication in the weight stationary mode is lower than the cost of executing the matrix multiplication in the output stationary mode. Therefore, the compiler tool may select to execute the matrix multiplication of the present matrices on the present systolic array in the weight stationary mode.

In some implementations, a non-transitory computer-readable medium may include instructions that, when executed by a processing unit, cause the processing unit to operate a compiler tool for selecting between executing a matrix multiplication operation in a weight stationary mode or in an output stationary mode on a systolic array with reconfigurable processing elements, wherein the matrix multiplication operation comprises a multiplication of a first matrix with a second matrix to determine a result matrix, and the instructions including the operations 810 to 890 of FIGS. 8A and 8B.

While the present technology is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

As will be appreciated by those of ordinary skill in the art, aspects of the presented technology may be embodied as a system, device, method, or computer program product apparatus. Accordingly, elements of the present disclosure may be implemented entirely in hardware, entirely in software (including firmware, resident software, micro-code, or the like) or in software and hardware that may all generally be referred to herein as a “apparatus,” “circuit,” “circuitry,” “module,” “computer,” “logic,” “FPGA,” “unit,” “system,” or other terms.

Furthermore, aspects of the presented technology may take the form of a computer program product embodied in one or more computer-readable medium(s) having computer program code stored thereon. The phrases “computer program code” and “instructions” both explicitly include configuration information for a CGRA, an FPGA, or other programmable logic as well as traditional binary computer instructions, and the term “processor” explicitly includes logic in a CGRA, an FPGA, or other programmable logic configured by the configuration information in addition to a traditional processing core. Furthermore, “executed” instructions explicitly includes electronic circuitry of a CGRA, an FPGA, or other programmable logic performing the functions for which they are configured by configuration information loaded from a storage medium as well as serial or parallel execution of instructions by a traditional processing core.

Any combination of one or more computer-readable storage medium(s) may be utilized. A computer-readable storage medium may be embodied as, for example, an electronic, magnetic, optical, electromagnetic, infrared, or semiconductor system, apparatus, or device, or other like storage devices known to those of ordinary skill in the art, or any suitable combination of computer-readable storage mediums described herein. In the context of this document, a computer-readable storage medium may be any tangible medium that can contain, or store, a program and/or data for use by or in connection with an instruction execution system, apparatus, or device. Even if the data in the computer-readable storage medium requires action to maintain the storage of data, such as in a traditional semiconductor-based dynamic random-access memory, the data storage in a computer-readable storage medium can be considered to be non-transitory.

A computer data transmission medium, such as a transmission line, a coaxial cable, a radio-frequency carrier, and the like, may also be able to store data, although any data storage in a data transmission medium can be said to be transitory storage. Nonetheless, a computer-readable storage medium, as the term is used herein, does not include a computer data transmission medium.

Computer program code for carrying out operations for aspects of the present technology may be written in any combination of one or more programming languages, including object-oriented programming languages such as Java, Python, C++, or the like, conventional procedural programming languages, such as the “C” programming language or similar programming languages, or low-level computer languages, such as assembly language or microcode. In addition, the computer program code may be written in VHDL, Verilog, or another hardware description language to generate configuration instructions for an FPGA, CGRA IC, or other programmable logic.

The computer program code if converted into an executable form and loaded onto a computer, FPGA, CGRA IC, or other programmable apparatus, produces a computer implemented method. The instructions which execute on the computer, FPGA, CGRA IC, or other programmable apparatus may provide the mechanism for implementing some or all of the functions/acts specified in the flowchart and/or block diagram block or blocks. In accordance with various implementations, the computer program code may execute entirely on the user's device, partly on the user's device and partly on a remote device, or entirely on the remote device, such as a cloud-based server. In the latter scenario, the remote device may be connected to the user's device through any type of network, including a local area network (LAN) or a wide area network (WAN), or the connection may be made to an external computer (for example, through the Internet using an Internet Service Provider). The computer program code stored in/on (i.e. embodied therewith) the non-transitory computer-readable medium produces an article of manufacture.

The computer program code, if executed by a processor, causes physical changes in the electronic devices of the processor which change the physical flow of electrons through the devices. This alters the connections between devices which changes the functionality of the circuit. For example, if two transistors in a processor are wired to perform a multiplexing operation under control of the computer program code, if a first computer instruction is executed, electrons from a first source flow through the first transistor to a destination, but if a different computer instruction is executed, electrons from the first source are blocked from reaching the destination, but electrons from a second source are allowed to flow through the second transistor to the destination. So, a processor programmed to perform a task is transformed from what the processor was before being programmed to perform that task, much like a physical plumbing system with different valves can be controlled to change the physical flow of a fluid.

Example 1 is a method of operating a compiler tool for selecting between executing a matrix multiplication operation in a weight stationary mode or in an output stationary mode on a systolic array with reconfigurable processing elements, wherein the matrix multiplication operation comprises a multiplication of a first matrix with a second matrix to determine a result matrix, comprising: receiving configuration parameters of the systolic array; receiving energy parameters related to executing predetermined operations on the systolic array; receiving performance parameters related to executing the predetermined operations on the systolic array; receiving first dimensions of the first matrix and second dimensions of the second matrix; estimating a first energy consumption of executing the matrix multiplication operation on the systolic array in the weight stationary mode based on the energy parameters, the configuration parameters, and the first and second dimensions; estimating a first performance number of executing the matrix multiplication operation on the systolic array in the weight stationary mode based on the performance parameters, the configuration parameters, and the first and second dimensions; estimating a second energy consumption of executing the matrix multiplication operation in the systolic array in the output stationary mode based on the energy parameters, the configuration parameters, and the first and second dimensions; estimating a second performance number of executing the matrix multiplication operation on the systolic array in the output stationary mode based on the performance parameters, the configuration parameters, and the first and second dimensions; and selecting between executing the matrix multiplication operation on the systolic array in the weight stationary mode and in the output stationary mode based on the first and second energy consumption and the first and second performance numbers.

In example 2, selecting between executing the matrix multiplication operation on the systolic array in the weight stationary mode and the output stationary mode based on the first and second energy consumption and the first and second performance numbers of Example 1 further comprises: determining a first value based on the first energy consumption and the first performance number; determining a second value based on the second energy consumption and the second performance number; and selecting to execute the matrix multiplication operation in the weight stationary mode or in the output stationary mode based on a comparison of the first and second values.

In Example 3, determining the first value of Example 2 comprises determining a first weighted cost of the first energy consumption and the first performance number, determining the second value comprises determining a second weighted cost of the second energy consumption and the second performance number, and selecting to execute the matrix multiplication operation in the weight stationary mode or in the output stationary mode based on the comparison of the first and second values further comprises: determining whether the first weighted cost is lower than the second weighted cost; in response to determining that the first weighted cost is lower than the second weighted cost, selecting to execute the matrix multiplication operation in the weight stationary mode; and in response to determining that the second weighted cost is lower than the first weighted cost, selecting to execute the matrix multiplication operation in the output stationary mode.

In Example 4, the systolic array of Example 1 is coupled to external memory, and the configuration parameters of the systolic array comprise a number of rows of reconfigurable processing elements, a number of columns of reconfigurable processing elements, a number of input memory blocks, a size of one input memory block, a number of output memory blocks, a size of one output memory block, an operating frequency, or a bandwidth for transmitting data to and receiving data from the external memory.

In Example 5, the first dimensions of Example 4 comprise a first number of rows and a first number of columns of the first matrix, and the second dimensions comprise a second number of rows and a second number of columns of the second matrix, further comprising: determining a total number of multiply-accumulate operations based on the first and second dimensions; determining a first number of row iterations for executing the matrix multiplication operation on the systolic array in the weight stationary mode based on the second number of rows and the number of rows of reconfigurable processing elements; determining a first number of column iterations for executing the matrix multiplication operation on the systolic array in the weight stationary mode based on the second number of columns and the number of columns of reconfigurable processing elements; determining a second number of row iterations for executing the matrix multiplication operation on the systolic array in the output stationary mode based on the first number of rows and the number of rows of reconfigurable processing elements; and determining a second number of column iterations for executing the matrix multiplication operation on the systolic array in the output stationary mode based on the second number of columns and the number of columns of reconfigurable processing elements.

In Example 6, the systolic array of Example 5 comprises compute units and memory units, and wherein receiving energy consumption parameters related to executing predetermined operations on the systolic array comprises: receiving a first energy consumption parameter related to executing a multiply-accumulate operation in the compute units; receiving a second energy consumption parameter related to accessing a memory unit of the memory units; receiving a third energy consumption parameter related to accessing the external memory; and receiving a fourth energy consumption parameter related to moving a bit of data over a predetermined distance on the systolic array.

In Example 7, the first and second matrices of Example 6 are stored in the external memory, wherein the result matrix is written to the external memory upon completion of the matrix multiplication operation, wherein the first, second, and result matrices have respective first, second, and third storage sizes, further comprising: partitioning the number of input memory blocks into a first number of input memory blocks for receiving the first matrix and a second number of input memory blocks for receiving the second matrix; determining a first input buffer size based on multiplying the first number of input memory blocks with the size of one input memory block; determining a second input buffer size based on multiplying the second number of input memory blocks with the size of one input memory block; determining an output buffer size based on multiplying the number of output memory blocks with the size of one output memory block; determining a first transferred quantity of data that is transferred between the external memory and the memory units for executing the matrix multiplication operation on the systolic array in the weight stationary mode based at least in part on the first input buffer size, the first storage size, the output buffer size, the third storage size, the first number of row iterations, or the first number of column operations; and determining a second transferred quantity of data that is transferred between the external memory and the memory units for executing the matrix multiplication operation on the systolic array in the output stationary mode based at least in part on the first input buffer size, the first storage size, the second input buffer size, the second storage size, the second number of row iterations, or the second number of column iterations.

In Example 8, determining the first transferred quantity of data of Example 7 further comprises: determining a tile size of the first matrix based on the first number of rows of the first matrix and the number of rows of reconfigurable processing elements; determining whether the tile size of the first matrix is greater than the first input buffer size; in response to determining that the tile size is greater than the first input buffer size, determining a first transferred sub-quantity of data as the first storage size times the first number of column iterations; in response to determining that the tile size is not greater than the first input buffer size, determining the first transferred sub-quantity of data as the first storage size; determining whether the third storage size is greater than the output buffer size; in response to determining that the third storage size is greater than the output buffer size, determining a second transferred sub-quantity of data as the first number of row iterations times two times the third storage size; in response to determining that the third storage size is not greater than the output buffer size, determining the second transferred sub-quantity of data as the third storage size; and determining the first transferred quantity of data as a sum of the first and second transferred sub-quantities of data and the second storage size.

In Example 9, determining the second transferred quantity of data of Example 7 further comprises: determining a first tile size of the first matrix based on the first number of columns of the first matrix and the number of rows of reconfigurable processing elements; determining a second tile size of the second matrix based on the second number of rows of the second matrix and the number of columns of reconfigurable processing elements; determining whether the first storage size is greater than the first input buffer size and whether the second storage size is greater than the second input buffer size; in response to determining that the first storage size is not greater than the first input buffer size and that the second storage size is not greater than the second input buffer size: determining a first transferred sub-quantity of data as the first storage size and a second transferred sub-quantity of data as the second storage size; in response to determining that the first storage size is greater than the first input buffer size and that the second storage size is not greater than the second input buffer size: determining the second transferred sub-quantity of data as the second storage size; determining whether the first tile size of the first matrix is greater than the first input buffer size; in response to determining that the first tile size is not greater than the first input buffer size, determining the first transferred sub-quantity of data as the first storage size times the first number of column iterations; in response to determining that the first storage size is not greater than the first input buffer size and that the second storage size is greater than the second input buffer size: determining the first transferred sub-quantity of data as the first storage size; determining whether the second tile size of the second matrix is greater than the second input buffer size; in response to determining that the second tile size is not greater than the second input buffer size, determining the second transferred sub-quantity of data as the second storage size times the second number of row iterations; in response to determining that the first storage size is greater than the first input buffer size and that the second storage size is greater than the second input buffer size: determining whether the first tile size of the first matrix is greater than the first input buffer size and whether the second tile size of the second matrix is greater than the second input buffer size; in response to determining that the first tile size is greater than the first input buffer size and that the second tile size is greater than the second input buffer size, determining the first transferred sub-quantity of data as the first storage size times the first number of row iterations times the first number of column iterations, and determining the second transferred sub-quantity of data as the second storage size times the second number of row iterations times the second number of column iterations; and determining the second transferred quantity of data as a sum of the first and second transferred sub-quantities of data and the third storage size.

In Example 10, estimating the first performance number of Example 7 further comprises: determining a first computation latency as a product of the first number of row iterations, the first number of column iterations, and the first number of rows, divided by the operating frequency; determining a first data access latency as a quotient of the first transferred quantity of data divided by the bandwidth for transmitting data to and receiving data from the external memory; and determining a total latency of the matrix multiplication operation by selecting the greater of the first computation latency and the first data access latency.

In Example 11, estimating the second performance number of Example 7 further comprises: determining a second computation latency as a product of the second number of row iterations, the second number of column iterations, and the second number of rows, divided by the operating frequency; determining a second data access latency as a quotient of the second transferred quantity of data divided by the bandwidth for transmitting data to and receiving data from the external memory; and determining a total latency of the matrix multiplication operation by selecting the greater of the second computation latency and the second data access latency.

In Example 12, estimating the first energy consumption of Example 7 further comprises: estimating a first portion of the first energy consumption by multiplying the total number of multiply-accumulate operations with the first energy consumption parameter; determining a data quantity written to and read from the memory units as a sum of the first storage size multiplied with the first number of column iterations, the second storage size, and the third storage size multiplied with the first number of row iterations; estimating a second portion of the first energy consumption based on the second energy consumption parameter and the data quantity written to and read from the memory units; estimating a third portion of the first energy consumption based on the third energy consumption parameter and the first transferred quantity of data; estimating a fourth portion of the first energy consumption based on the data quantity written to and read from the memory units, a width and a height of the systolic array, and the fourth energy consumption parameter; estimating a fifth portion of the first energy consumption based on the first transferred quantity of data, the width and the height of the systolic array, and the fourth energy consumption parameter; and estimating the first energy consumption based on a sum of the first, second, third, fourth, and fifth portions of the first energy consumption.

In Example 13, estimating the second energy consumption of Example 7 further comprises: estimating a first portion of the second energy consumption by multiplying the total number of multiply-accumulate operations with the first energy consumption parameter; determining a data quantity written to and read from the memory units as a sum of the first storage size multiplied with the second number of column iterations, the second storage size multiplied with the second number of row iterations, and the third storage size; estimating a second portion of the second energy consumption based on the second energy consumption parameter and the data quantity written to and read from the memory units; estimating a third portion of the second energy consumption based on the third energy consumption parameter and the second transferred quantity of data; estimating a fourth portion of the second energy consumption based on the data quantity written to and read from the memory units, a width and a height of the systolic array, and the fourth energy consumption parameter; estimating a fifth portion of the second energy consumption based on the second transferred quantity of data, the width and the height of the systolic array, and the fourth energy consumption parameter; and estimating the second energy consumption based on a sum of the first, second, third, fourth, and fifth portions of the second energy consumption.

Example 14 is a compiler tool for selecting between executing a matrix multiplication operation in a weight stationary mode or in an output stationary mode on a systolic array with reconfigurable processing elements, wherein the matrix multiplication operation comprises a multiplication of a first matrix with a second matrix to determine a result matrix, and wherein the compiler tool is configured to: receive configuration parameters of the systolic array; receive energy parameters related to executing predetermined operations on the systolic array; receive performance parameters related to executing the predetermined operations on the systolic array; receive first dimensions of the first matrix and second dimensions of the second matrix; estimate a first energy consumption of executing the matrix multiplication operation on the systolic array in the weight stationary mode based on the energy parameters, the configuration parameters, and the first and second dimensions; estimate a first performance number of executing the matrix multiplication operation on the systolic array in the weight stationary mode based on the performance parameters, the configuration parameters, and the first and second dimensions; estimate a second energy consumption of executing the matrix multiplication operation on the systolic array in the output stationary mode based on the energy parameters, the configuration parameters, and the first and second dimensions; estimate a second performance number of executing the matrix multiplication operation on the systolic array in the output stationary mode based on the performance parameters, the configuration parameters, and the first and second dimensions; and select between executing the matrix multiplication operation on the systolic array in the weight stationary mode and in the output stationary mode based on the first and second energy consumption and the first and second performance numbers.

In Example 15, for selecting between executing the matrix multiplication operation on the systolic array in the weight stationary mode and the output stationary mode based on the first and second energy consumption and the first and second performance numbers, the compiler tool of Example 14 is further configured to: determine a first value based on the first energy consumption and the first performance number; determine a second value based on the second energy consumption and the second performance number; and select to execute the matrix multiplication operation in the weight stationary mode or in the output stationary mode based on a comparison of the first and second values.

In Example 16, the systolic array of Example 14 is coupled to external memory, and wherein the configuration parameters of the systolic array comprise a number of rows of reconfigurable processing elements, a number of columns of reconfigurable processing elements, a number of input memory blocks, a size of one input memory block, a number of output memory blocks, a size of one output memory block, an operating frequency, or a bandwidth for transmitting data to and receiving data from the external memory.

In Example 17, the systolic array of Example 16 comprises compute units and memory units, wherein the first dimensions comprise a first number of rows and a first number of columns of the first matrix, wherein the second dimensions comprise a second number of rows and a second number of columns of the second matrix, and wherein the compiler tool is further configured to: determine a first number of row iterations for executing the matrix multiplication operation on the systolic array in the weight stationary mode based on the second number of rows and the number of rows of reconfigurable processing elements; determine a first number of column iterations for executing the matrix multiplication operation on the systolic array in the weight stationary mode based on the second number of columns and the number of columns of reconfigurable processing elements; determine a second number of row iterations for executing the matrix multiplication operation on the systolic array in the output stationary mode based on the first number of rows and the number of rows of reconfigurable processing elements; determine a second number of column iterations for executing the matrix multiplication operation on the systolic array in the output stationary mode based on the second number of columns and the number of columns of reconfigurable processing elements; determine a first transferred quantity of data that is transferred between the external memory and the memory units for executing the matrix multiplication operation on the systolic array in the weight stationary mode; and determine a second transferred quantity of data that is transferred between the external memory and the memory units for executing the matrix multiplication operation on the systolic array in the output stationary mode.

In Example 18, for estimating the first performance number, the compiler tool of Example 17 is further configured to: determine a first computation latency as a product of the first number of row iterations, the first number of column iterations, and the first number of rows, divided by the operating frequency; determine a first data access latency as a quotient of the first transferred quantity of data divided by the bandwidth for transmitting data to and receiving data from the external memory; and determine a total latency of the matrix multiplication operation by selecting the greater of the first computation latency and the first data access latency.

In Example 19, for estimating the second performance number, the compiler tool of Example 17 is further configured to: determine a second computation latency as a product of the second number of row iterations, the second number of column iterations, and the second number of rows, divided by the operating frequency; determine a second data access latency as a quotient of the second transferred quantity of data divided by the bandwidth for transmitting data to and receiving data from the external memory; and determine a total latency of the matrix multiplication operation by selecting the greater of the second computation latency and the second data access latency.

Example 20 is a non-transitory computer-readable storage medium including instructions that, when executed by a processing unit, cause the processing unit to operate a compiler tool for selecting between executing a matrix multiplication operation in a weight stationary mode or in an output stationary mode on a systolic array with reconfigurable processing elements, wherein the matrix multiplication operation comprises a multiplication of a first matrix with a second matrix to determine a result matrix, the instructions comprising: receiving configuration parameters of the systolic array; receiving energy parameters related to executing predetermined operations on the systolic array; receiving performance parameters related to executing the predetermined operations on the systolic array; receiving first dimensions of the first matrix and second dimensions of the second matrix; estimating a first energy consumption of executing the matrix multiplication operation on the systolic array in the weight stationary mode based on the energy parameters, the configuration parameters, and the first and second dimensions; estimating a first performance number of executing the matrix multiplication operation on the systolic array in the weight stationary mode based on the performance parameters, the configuration parameters, and the first and second dimensions; estimating a second energy consumption of executing the matrix multiplication operation on the systolic array in the output stationary mode based on the energy parameters, the configuration parameters, and the first and second dimensions; estimating a second performance number of executing the matrix multiplication operation on the systolic array in the output stationary mode based on the performance parameters, the configuration parameters, and the first and second dimensions; and selecting between executing the matrix multiplication operation on the systolic array in the weight stationary mode and in the output stationary mode based on the first and second energy consumption and the first and second performance numbers.

What is claimed is:

1. A method of operating a compiler tool for selecting between executing a matrix multiplication operation in a weight stationary mode or in an output stationary mode on a systolic array with reconfigurable processing elements, wherein the matrix multiplication operation comprises a multiplication of a first matrix with a second matrix to determine a result matrix, comprising:
receiving configuration parameters of the systolic array;
receiving energy parameters related to executing predetermined operations on the systolic array;
receiving performance parameters related to executing the predetermined operations on the systolic array;
receiving first dimensions of the first matrix and second dimensions of the second matrix;
estimating a first energy consumption of executing the matrix multiplication operation on the systolic array in the weight stationary mode based on the energy parameters, the configuration parameters, and the first and second dimensions;
estimating a first performance number of executing the matrix multiplication operation on the systolic array in the weight stationary mode based on the performance parameters, the configuration parameters, and the first and second dimensions;
estimating a second energy consumption of executing the matrix multiplication operation on the systolic array in the output stationary mode based on the energy parameters, the configuration parameters, and the first and second dimensions;
estimating a second performance number of executing the matrix multiplication operation on the systolic array in the output stationary mode based on the performance parameters, the configuration parameters, and the first and second dimensions; and
selecting between executing the matrix multiplication operation on the systolic array in the weight stationary mode and in the output stationary mode based on the first and second energy consumption and the first and second performance numbers.

2. The method of claim 1, wherein selecting between executing the matrix multiplication operation on the systolic array in the weight stationary mode and the output stationary mode based on the first and second energy consumption and the first and second performance numbers further comprises:
determining a first value based on the first energy consumption and the first performance number;
determining a second value based on the second energy consumption and the second performance number; and
selecting to execute the matrix multiplication operation in the weight stationary mode or in the output stationary mode based on a comparison of the first and second values.

3. The method of claim 2, wherein determining the first value comprises determining a first weighted cost of the first energy consumption and the first performance number, wherein determining the second value comprises determining a second weighted cost of the second energy consumption and the second performance number, and wherein selecting to execute the matrix multiplication operation in the weight stationary mode or in the output stationary mode based on the comparison of the first and second values further comprises:
determining whether the first weighted cost is lower than the second weighted cost;
in response to determining that the first weighted cost is lower than the second weighted cost, selecting to execute the matrix multiplication operation in the weight stationary mode; and
in response to determining that the second weighted cost is lower than the first weighted cost, selecting to execute the matrix multiplication operation in the output stationary mode.

4. The method of claim 1, wherein the systolic array is coupled to external memory, and wherein the configuration parameters of the systolic array comprise a number of rows of reconfigurable processing elements, a number of columns of reconfigurable processing elements, a number of input memory blocks, a size of one input memory block, a number of output memory blocks, a size of one output memory block, an operating frequency, or a bandwidth for transmitting data to and receiving data from the external memory.

5. The method of claim 4, wherein the first dimensions comprise a first number of rows and a first number of columns of the first matrix, and wherein the second dimensions comprise a second number of rows and a second number of columns of the second matrix, further comprising:
determining a total number of multiply-accumulate operations based on the first and second dimensions;
determining a first number of row iterations for executing the matrix multiplication operation on the systolic array in the weight stationary mode based on the second number of rows and the number of rows of reconfigurable processing elements;
determining a first number of column iterations for executing the matrix multiplication operation on the systolic array in the weight stationary mode based on the second number of columns and the number of columns of reconfigurable processing elements;
determining a second number of row iterations for executing the matrix multiplication operation on the systolic array in the output stationary mode based on the first number of rows and the number of rows of reconfigurable processing elements; and
determining a second number of column iterations for executing the matrix multiplication operation on the systolic array in the output stationary mode based on the second number of columns and the number of columns of reconfigurable processing elements.

6. The method of claim 5, wherein the systolic array comprises compute units and memory units, and wherein receiving energy consumption parameters related to executing predetermined operations on the systolic array comprises:
receiving a first energy consumption parameter related to executing a multiply-accumulate operation in the compute units;
receiving a second energy consumption parameter related to accessing a memory unit of the memory units;
receiving a third energy consumption parameter related to accessing the external memory; and
receiving a fourth energy consumption parameter related to moving a bit of data over a predetermined distance on the systolic array.

7. The method of claim 6, wherein the first and second matrices are stored in the external memory, wherein the result matrix is written to the external memory upon completion of the matrix multiplication operation, wherein the first, second, and result matrices have respective first, second, and third storage sizes, further comprising:
partitioning the number of input memory blocks into a first number of input memory blocks for receiving the first matrix and a second number of input memory blocks for receiving the second matrix;
determining a first input buffer size based on multiplying the first number of input memory blocks with the size of one input memory block;
determining a second input buffer size based on multiplying the second number of input memory blocks with the size of one input memory block;
determining an output buffer size based on multiplying the number of output memory blocks with the size of one output memory block;
determining a first transferred quantity of data that is transferred between the external memory and the memory units for executing the matrix multiplication operation on the systolic array in the weight stationary mode based at least in part on the first input buffer size, the first storage size, the output buffer size, the third storage size, the first number of row iterations, or the first number of column operations; and
determining a second transferred quantity of data that is transferred between the external memory and the memory units for executing the matrix multiplication operation on the systolic array in the output stationary mode based at least in part on the first input buffer size, the first storage size, the second input buffer size, the second storage size, the second number of row iterations, or the second number of column iterations.

8. The method of claim 7, wherein determining the first transferred quantity of data further comprises:
determining a tile size of the first matrix based on the first number of rows of the first matrix and the number of rows of reconfigurable processing elements;
determining whether the tile size of the first matrix is greater than the first input buffer size;
in response to determining that the tile size is greater than the first input buffer size, determining a first transferred sub-quantity of data as the first storage size times the first number of column iterations;
in response to determining that the tile size is not greater than the first input buffer size, determining the first transferred sub-quantity of data as the first storage size;
determining whether the third storage size is greater than the output buffer size;
in response to determining that the third storage size is greater than the output buffer size, determining a second transferred sub-quantity of data as the first number of row iterations times two times the third storage size;
in response to determining that the third storage size is not greater than the output buffer size, determining the second transferred sub-quantity of data as the third storage size; and
determining the first transferred quantity of data as a sum of the first and second transferred sub-quantities of data and the second storage size.

9. The method of claim 7, wherein determining the second transferred quantity of data further comprises:
determining a first tile size of the first matrix based on the first number of columns of the first matrix and the number of rows of reconfigurable processing elements;
determining a second tile size of the second matrix based on the second number of rows of the second matrix and the number of columns of reconfigurable processing elements;
determining whether the first storage size is greater than the first input buffer size and whether the second storage size is greater than the second input buffer size;
in response to determining that the first storage size is not greater than the first input buffer size and that the second storage size is not greater than the second input buffer size:
determining a first transferred sub-quantity of data as the first storage size and a second transferred sub-quantity of data as the second storage size;
in response to determining that the first storage size is greater than the first input buffer size and that the second storage size is not greater than the second input buffer size:
determining the second transferred sub-quantity of data as the second storage size;
determining whether the first tile size of the first matrix is greater than the first input buffer size;
in response to determining that the first tile size is not greater than the first input buffer size, determining the first transferred sub-quantity of data as the first storage size times the first number of column iterations;
in response to determining that the first storage size is not greater than the first input buffer size and that the second storage size is greater than the second input buffer size:
determining the first transferred sub-quantity of data as the first storage size;
determining whether the second tile size of the second matrix is greater than the second input buffer size;
in response to determining that the second tile size is not greater than the second input buffer size, determining the second transferred sub-quantity of data as the second storage size times the second number of row iterations;
in response to determining that the first storage size is greater than the first input buffer size and that the second storage size is greater than the second input buffer size:
determining whether the first tile size of the first matrix is greater than the first input buffer size and whether the second tile size of the second matrix is greater than the second input buffer size;
in response to determining that the first tile size is greater than the first input buffer size and that the second tile size is greater than the second input buffer size, determining the first transferred sub-quantity of data as the first storage size times the first number of row iterations times the first number of column iterations, and determining the second transferred sub-quantity of data as the second storage size times the second number of row iterations times the second number of column iterations; and
determining the second transferred quantity of data as a sum of the first and second transferred sub-quantities of data and the third storage size.

10. The method of claim 7, wherein estimating the first performance number further comprises:
determining a first computation latency as a product of the first number of row iterations, the first number of column iterations, and the first number of rows, divided by the operating frequency;
determining a first data access latency as a quotient of the first transferred quantity of data divided by the bandwidth for transmitting data to and receiving data from the external memory; and
determining a total latency of the matrix multiplication operation by selecting the greater of the first computation latency and the first data access latency.

11. The method of claim 7, wherein estimating the second performance number further comprises:
determining a second computation latency as a product of the second number of row iterations, the second number of column iterations, and the second number of rows, divided by the operating frequency;
determining a second data access latency as a quotient of the second transferred quantity of data divided by the bandwidth for transmitting data to and receiving data from the external memory; and
determining a total latency of the matrix multiplication operation by selecting the greater of the second computation latency and the second data access latency.

12. The method of claim 7, and wherein estimating the first energy consumption further comprises:
estimating a first portion of the first energy consumption by multiplying the total number of multiply-accumulate operations with the first energy consumption parameter;
determining a data quantity written to and read from the memory units as a sum of the first storage size multiplied with the first number of column iterations, the second storage size, and the third storage size multiplied with the first number of row iterations;
estimating a second portion of the first energy consumption based on the second energy consumption parameter and the data quantity written to and read from the memory units;
estimating a third portion of the first energy consumption based on the third energy consumption parameter and the first transferred quantity of data;
estimating a fourth portion of the first energy consumption based on the data quantity written to and read from the memory units, a width and a height of the systolic array, and the fourth energy consumption parameter;
estimating a fifth portion of the first energy consumption based on the first transferred quantity of data, the width and the height of the systolic array, and the fourth energy consumption parameter; and
estimating the first energy consumption based on a sum of the first, second, third, fourth, and fifth portions of the first energy consumption.

13. The method of claim 7, wherein estimating the second energy consumption further comprises:
estimating a first portion of the second energy consumption by multiplying the total number of multiply-accumulate operations with the first energy consumption parameter;
determining a data quantity written to and read from the memory units as a sum of the first storage size multiplied with the second number of column iterations, the second storage size multiplied with the second number of row iterations, and the third storage size;
estimating a second portion of the second energy consumption based on the second energy consumption parameter and the data quantity written to and read from the memory units;
estimating a third portion of the second energy consumption based on the third energy consumption parameter and the second transferred quantity of data;
estimating a fourth portion of the second energy consumption based on the data quantity written to and read from the memory units, a width and a height of the systolic array, and the fourth energy consumption parameter;
estimating a fifth portion of the second energy consumption based on the second transferred quantity of data, the width and the height of the systolic array, and the fourth energy consumption parameter; and
estimating the second energy consumption based on a sum of the first, second, third, fourth, and fifth portions of the second energy consumption.

14. A compiler tool for selecting between executing a matrix multiplication operation in a weight stationary mode or in an output stationary mode on a systolic array with reconfigurable processing elements, wherein the matrix multiplication operation comprises a multiplication of a first matrix with a second matrix to determine a result matrix, and wherein the compiler tool is configured to:
receive configuration parameters of the systolic array;
receive energy parameters related to executing predetermined operations on the systolic array;
receive performance parameters related to executing the predetermined operations on the systolic array;
receive first dimensions of the first matrix and second dimensions of the second matrix;
estimate a first energy consumption of executing the matrix multiplication operation on the systolic array in the weight stationary mode based on the energy parameters, the configuration parameters, and the first and second dimensions;
estimate a first performance number of executing the matrix multiplication operation on the systolic array in the weight stationary mode based on the performance parameters, the configuration parameters, and the first and second dimensions;
estimate a second energy consumption of executing the matrix multiplication operation on the systolic array in the output stationary mode based on the energy parameters, the configuration parameters, and the first and second dimensions;
estimate a second performance number of executing the matrix multiplication operation on the systolic array in the output stationary mode based on the performance parameters, the configuration parameters, and the first and second dimensions; and
select between executing the matrix multiplication operation on the systolic array in the weight stationary mode and in the output stationary mode based on the first and second energy consumption and the first and second performance numbers.

15. The compiler tool of claim 14, that, for selecting between executing the matrix multiplication operation on the systolic array in the weight stationary mode and the output stationary mode based on the first and second energy consumption and the first and second performance numbers, is further configured to:
determine a first value based on the first energy consumption and the first performance number;
determine a second value based on the second energy consumption and the second performance number; and
select to execute the matrix multiplication operation in the weight stationary mode or in the output stationary mode based on a comparison of the first and second values.

16. The compiler tool of claim 14, wherein the systolic array is coupled to external memory, and wherein the configuration parameters of the systolic array comprise a number of rows of reconfigurable processing elements, a number of columns of reconfigurable processing elements, a number of input memory blocks, a size of one input memory block, a number of output memory blocks, a size of one output memory block, an operating frequency, or a bandwidth for transmitting data to and receiving data from the external memory.

17. The compiler tool of claim 16, wherein the systolic array comprises compute units and memory units, wherein the first dimensions comprise a first number of rows and a first number of columns of the first matrix, wherein the second dimensions comprise a second number of rows and a second number of columns of the second matrix, and wherein the compiler tool is further configured to:
determine a first number of row iterations for executing the matrix multiplication operation on the systolic array in the weight stationary mode based on the second number of rows and the number of rows of reconfigurable processing elements;
determine a first number of column iterations for executing the matrix multiplication operation on the systolic array in the weight stationary mode based on the second number of columns and the number of columns of reconfigurable processing elements;
determine a second number of row iterations for executing the matrix multiplication operation on the systolic array in the output stationary mode based on the first number of rows and the number of rows of reconfigurable processing elements;
determine a second number of column iterations for executing the matrix multiplication operation on the systolic array in the output stationary mode based on the second number of columns and the number of columns of reconfigurable processing elements;
determine a first transferred quantity of data that is transferred between the external memory and the memory units for executing the matrix multiplication operation on the systolic array in the weight stationary mode; and
determine a second transferred quantity of data that is transferred between the external memory and the memory units for executing the matrix multiplication operation on the systolic array in the output stationary mode.

18. The compiler tool of claim 17, that, for estimating the first performance number, is further configured to:
determine a first computation latency as a product of the first number of row iterations, the first number of column iterations, and the first number of rows, divided by the operating frequency;
determine a first data access latency as a quotient of the first transferred quantity of data divided by the bandwidth for transmitting data to and receiving data from the external memory; and
determine a total latency of the matrix multiplication operation by selecting the greater of the first computation latency and the first data access latency.

19. The compiler tool of claim 17, that, for estimating the second performance number, is further configured to:
determine a second computation latency as a product of the second number of row iterations, the second number of column iterations, and the second number of rows, divided by the operating frequency;
determine a second data access latency as a quotient of the second transferred quantity of data divided by the bandwidth for transmitting data to and receiving data from the external memory; and
determine a total latency of the matrix multiplication operation by selecting the greater of the second computation latency and the second data access latency.

20. A non-transitory computer-readable storage medium including instructions that, when executed by a processing unit, cause the processing unit to operate a compiler tool for selecting between executing a matrix multiplication operation in a weight stationary mode or in an output stationary mode on a systolic array with reconfigurable processing elements, wherein the matrix multiplication operation comprises a multiplication of a first matrix with a second matrix to determine a result matrix, the instructions comprising:
receiving configuration parameters of the systolic array;
receiving energy parameters related to executing predetermined operations on the systolic array;
receiving performance parameters related to executing the predetermined operations on the systolic array;
receiving first dimensions of the first matrix and second dimensions of the second matrix;
estimating a first energy consumption of executing the matrix multiplication operation on the systolic array in the weight stationary mode based on the energy parameters, the configuration parameters, and the first and second dimensions;
estimating a first performance number of executing the matrix multiplication operation on the systolic array in the weight stationary mode based on the performance parameters, the configuration parameters, and the first and second dimensions;
estimating a second energy consumption of executing the matrix multiplication operation on the systolic array in the output stationary mode based on the energy parameters, the configuration parameters, and the first and second dimensions;
estimating a second performance number of executing the matrix multiplication operation on the systolic array in the output stationary mode based on the performance parameters, the configuration parameters, and the first and second dimensions; and
selecting between executing the matrix multiplication operation on the systolic array in the weight stationary mode and in the output stationary mode based on the first and second energy consumption and the first and second performance numbers.
